(19) United States
(12) Patent Application Publication
(10) Pub. No.: US 2025/0320362 A1
(43) Pub. Date: Oct. 16, 2025

(54) Suspensions and Solutions of Dyes For Colored Coatings

(71) Applicant: Northeastern University, Boston, MA (US)

(72) Inventors: Kaitlyn R. Flynn, Clarkston, WA (US); Cassandra Leigh Martin, Wilmington, MA (US); Leila Deravi, Cambridge, MA (US); Daniel Wilson, Medford, MA (US)

(21) Appl. No.: 18/873,371

(22) PCT Filed: Jun. 12, 2023
(86) PCT No.: PCT/US2023/068308

§ 371 Date: Dec. 10, 2024

Related U.S. Application Data
(60) Provisional application No. 63/351,644, filed on Jun. 13, 2022.
(60) Provisional application No. 63/406,064, filed on Sep. 13, 2022.

(51) Int. Cl. C09D 4/00; C09D 7/20; C09D 17/00

(52) U.S. Cl. CPC C09D 4/00; C09D 7/20; C09D 17/008

(57) ABSTRACT

Described herein are compositions comprising xanthommatin, or a derivative or precursor thereof, and a paint matrix. Within the composition, the xanthommatin, or a derivative or precursor thereof, is in molecular form, not as a particle, and is uniformly distributed throughout a paint matrix. This provides paint coatings with specific thermal performance and desired visible color. Also described herein are methods of preparing and using the compositions described herein.

### RELATED APPLICATIONS

This application claims the benefit of U.S. Provisional Application No. 63/351,644, filed on Jun. 13, 2022, and U.S. Provisional Application No. 63/406,064, filed on Sep. 13, 2022. The entire teachings of the above applications are incorporated herein by reference.

### GOVERNMENT SUPPORT

This invention was made with government support under Grant Number W911QY-19-9-0011 awarded by the U.S. Army Combat Capabilities Development Command Soldier Center. The government has certain rights in the invention.

### BACKGROUND

Pigments that provide color to paints are typically inorganic materials that exist as solid particles or finely ground powders. Conventionally, pigment particles are dispersed uniformly throughout the paint matrix and provide color by selectively absorbing most wavelengths of light but reflecting the remaining wavelengths to produce the color perceived by the viewer. The physical/chemical properties of a pigment determine which visible wavelengths the pigment will absorb. Pigments that absorb, rather than reflect, a considerable amount of total energy make it challenging to manage the temperature of painted surfaces. There is considerable interest in creating pigments with tailored performance for thermal and color management (e.g., energy-efficient temperature regulation).

Reflective materials (e.g., aluminum flakes) can be incorporated into paints to provide thermal management. Because these materials can cause painted surfaces to appear metallic and/or diminish the performance of pigments blended to provide visible color, paint manufacturers have developed processes for coating these materials, often metallic effect pigments, with visibly colored pigments (e.g., titanium dioxide) using binder systems (e.g., metal oxides, organic polymers). These coating systems are intended to provide a desirable visible color while also providing thermal management. White coatings, which absorb minimal irradiation energy, have a high total solar reflectance (TSR) and are typically chosen to keep surfaces cool, while black pigments are effective absorbers and offer reduced thermal management performance. This means that paints offering both dark/rich colors within the visible spectrum and thermal management properties are challenging to develop because they typically require incorporation of black pigments which decrease thermal management performance.

A number of color-changing consumer goods are also currently available. In the apparel and textile industries, several thermochromic dyes have been incorporated into clothing and fabrics to create controlled and vibrant changes in fabric color. While the leuco dyes and liquid crystal materials that enable thermochromic performance offer reproducible color switching, these technologies can require substantial energy from an outside source to function. In cases where localized heating is not possible or preferred, using natural/ambient sources of energy (e.g., sunlight) can be preferred.

Photochromic dyes can undergo reversible changes in their chemical structure (e.g., cis-trans isomerization or ring opening/closure reactions) in response to light, typically ultraviolet light. These molecules are the basis of color and opacity changing lenses for glasses (e.g., transition lenses) and have been improved since their introduction to offer a broader color palette and formulation/application vehicles (e.g., paints). The color transitions of these formulations are generally rapid (circa one hour).

Iridescent paint products have been advertised as “color-changing” (e.g., chameleon paints), but the perceived color of these coatings is dependent on the viewing angle at which an observer inspects a painted surface. In this example, perceived color is not easily controlled and the observed color changing effect varies considerably based on the relative positions of the painted surface and the observer.

Accordingly, there is a need for additional paint formulations, particularly those in which the pigment does not influence the thermal performance of the paint.

### SUMMARY

This disclosure is based, at least in part, on the observation that coating formulations incorporating xanthommatin in molecular form, not as a particle, wherein the xanthommatin is uniformly distributed throughout a paint matrix, support development of paint coatings with specific thermal performance and desired visible color, a scenario for which few products are commercially available today.

Described herein are compositions comprising xanthommatin, or a derivative or precursor thereof, and a paint matrix, wherein the xanthommatin, or a derivative or precursor thereof, is in non-aggregated form and is about 0.001% to about 20% weight/weight (w/w) of the composition.

Also described herein are compositions comprising xanthommatin, or a derivative or precursor thereof, and a polymeric matrix, wherein the xanthommatin, or a derivative or precursor thereof, is in non-aggregated form and is about 0.001% to about 20% w/w of the composition.

Also described herein are compositions comprising xanthommatin, or a derivative or precursor thereof, and a polymeric matrix, wherein the xanthommatin, or a derivative or precursor thereof, is in non-aggregated form and is about 0.001% to about 10% w/w of the composition.

Also described herein are compositions comprising xanthommatin, or a derivative or precursor thereof, titanium dioxide, and a water-based polyurethane paint matrix.

Also described herein is a method for modulating the color or thermal properties or both of a surface, the method comprising applying a composition described herein to the surface, or a portion thereof, thereby forming a coating of the composition on the surface, or a portion thereof.

Also described herein is a method for modulating the thermal properties of a surface, the method comprising applying a composition described herein to the surface, or a portion thereof, thereby forming a coating of the composition on the surface, or a portion thereof.

Also described herein is a method for modulating the color or thermal properties or both of paint or a paint matrix, comprising dissolving xanthommatin, or a derivative or precursor thereof, in the paint or paint matrix in an amount sufficient to achieve about 0.001% to about 20% w/w of the xanthommatin, or a derivative or precursor thereof.

Also described herein is a method for making a composition described herein, comprising dissolving xanthommatin, or a derivative or precursor thereof, in a paint matrix in an amount sufficient to achieve about 0.001% to about 20% w/w of the xanthommatin, or a derivative or precursor thereof, in the composition.

In the compositions (e.g., paint formulations) described herein, the visibly colored pigment, typically, the biological molecule xanthommatin, does not influence the thermal performance of the paint as conventional pigments do. In addition, the compositions allow access to a range of visible paint colors (e.g., red, yellow, tan, brown) without influencing the thermal management of the paint system as conventional pigments do.

The disclosed formulations are unique in that they incorporate pigments imparting dark colors (e.g., reds, browns), which can be achieved by controlling chemical properties of the primary pigment, xanthommatin, which is distributed as a solution or suspension throughout the paint matrix in molecular form. This means that xanthommatin can be incorporated into paint formulations as a solution, not as a particle suspension or colloid, to augment or tune visible color.

Xanthommatin-based coatings may also be applied to metallic effect pigments (e.g., aluminum flakes) to provide an enhancement over the visibly colored pigments used in these paint systems today. The optical properties of xanthommatin provide substantial opportunities for broadening the capabilities of coating systems that require specific performance in the visible spectra. Traditional pigments offer only a single color. In the present formulations, the oxidation state of xanthommatin can be controlled to provide a range of colors with inexpensive additives (e.g., oxidizing and reducing agents). For example, paint prepared using xanthommatin and TiO₂, a common paint colorant, undergoes color changes that are based on reversible changes in oxidation state. These color changes do not require substantial amounts of input energy that impart localized heating and also occur in a manner that is fundamentally different from how typical/existing photochromic dyes function.

The disclosed formulations are also environmentally friendly and safe. Xanthommatin is a biological molecule derived from natural materials, and is nontoxic and environmentally-friendly. Many commercially available pigments that are used to create red and yellow colors are known to be hazardous. Examples include cadmium-based red and yellow colors (e.g., cadmium sulfide, cadmium selenide) and chromate-based yellow colors (e.g., lead chromate, strontium chromate, zinc chromate). The possibility of creating similarly or equivalently colored paints using xanthommatin instead of these pigments provides an opportunity to develop new products that are user-friendly and environmentally responsible. Furthermore, xanthommatin can be added to pre-existing paint formulations.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments.

FIG. 1A shows that dissolved pigment concentration controls visible color in water-based polyurethane paint formulations prepared using solutions or suspensions of xanthommatin.

FIG. 1B is a graph of visible color of paint formulations in FIG. 1A, measured by pixel intensity (RGB color space, blue channel).

FIG. 1C shows xanthommatin solubility in water. The pigment is most soluble in basic conditions, and is sparingly soluble/insoluble in acidic conditions. Solubility evaluated by suspending solid pigment in acidic to alkaline water (pH 2-12), and subjecting to physical agitation (e.g., mixing, sonication) and then sedimentation by centrifugation.

FIG. 1D shows pigment solubility in water-based polyurethane. Pigment prepared as a suspension (in water) or as a solution (in MES buffer) was fully soluble in water-based polyurethane paint base. When pigment in each carrier liquid was combined with paint base, the absence of solid material after centrifugation, relative to the visible mass of starting pigment, indicated that roughly all of the pigment was fully dissolved in the paint matrix.

FIG. 1E shows dissolved oxidized xanthommatin (tan/brown) blended with conventional pigment (Prussian Blue) provides a complementary hue (green).

FIG. 2 shows a comparison of some of the xanthommatin and TiO₂ paint after being exposed to a solar lamp for one hour.

FIG. 3 shows a comparison of B values for three specific ratios of xanthommatin to TiO₂.

FIG. 4A is images showing passive re-oxidation of the Xa paint over a span of 24 hours.

FIG. 4B is images showing the reversible color change over four photoreduction and re-oxidation cycles.

FIG. 5 shows xanthommatin mixed with 1:100 Xa: Nano TiO₂ and ultramarine.

FIG. 6A shows photoreduction of Xa-based coatings in sunlight, with changes in hue angle for coatings containing Xa and larger TiO₂ particles over 60 minutes of irradiation. Results depict an average of three formulation replicates and error is reported as standard deviation.

FIG. 6B shows photoreduction of Xa-based coatings in sunlight, with changes in hue angle for coatings containing Xa and smaller TiO₂ particles over 60 minutes of irradiation. Results depict an average of three formulation replicates and error is reported as standard deviation.

FIG. 6C shows representative images of color-changing coatings prepared using larger TiO₂ particles. Images represent approximately 400 mm² of coating surface.

FIG. 6D shows representative images of color-changing coatings prepared using smaller TiO₂ particles. Images represent approximately 400 mm² of coating surface.

FIG. 6E shows a CIELAB color coordinate diagram depicting chromaticity values of Xa-based coatings before and after irradiation.

FIG. 7A shows the reversibility of light-driven color change. Representative images for coatings composed of larger TiO₂ particles before irradiation, immediately after irradiation, and 72 hours after irradiation. Images represent approximately 400 mm² of coating surface.

FIG. 7B shows the reversibility of light-driven color change. Representative images for coatings composed of smaller TiO₂ particles before irradiation, immediately after irradiation, and 72 hours after irradiation. Images represent approximately 400 mm² of coating surface.

FIG. 7C shows the percent change in hue angle of the 1:50, 1:100, and 1:150 Xa to TiO₂ coatings for the larger TiO₂ particle formulation during the 72-hour period after the sample was irradiated. The red dashed line indicates where the percent change in the hue angle is equal to zero. Results are an average of three formulation replicates and error is reported as standard deviation.

FIG. 7D shows the percent change in hue angle of the 1:50, 1:100, and 1:150 Xa to TiO₂ coatings with the smaller TiO₂ particle formulation during the 72-hour period after the sample was irradiated. The red dashed line indicates where the percent change in the hue angle is equal to zero. Results are an average of three formulation replicates and error is reported as standard deviation.

FIG. 7E shows a cycling experiment wherein a 1:100 sample, both with larger and smaller TiO₂ particles was irradiated and relaxed seven times to demonstrate that the coating could repeatedly switch between their two colors, without a significant change in the color. Results are an average of three formulation replicates and error is reported as standard deviation.

FIG. 8A is a schematic depicting the formulation approach used to control the rate and intensity of Xa photoreduction via TiO₂ particle size and loading density. The polyurethane paint base provides differential penetration of UVA, UVB, and UVC radiation thorough the paint matrix

FIG. 8B shows the energy dependence of photochromism in Xa-based paints by the hue angle shift observed in 1:100 Xa: TiO₂ formulations (smaller particles). Results include representative images before and after irradiation and results are the average of three formulation replicates. Error is reported as standard deviation.

FIG. 8C shows the Tauc plots for the direct energy bandgaps of TiO₂ and Xa that were extrapolated from their UV-Vis absorbance profiles. Dashed lines represent the tangent lines that were calculated to determine energy bandgaps.

FIG. 8D shows a comparison of the HOMO and LUMO positions of TiO₂ and Xa at pH 7 and the corresponding direct energy bandgaps.

FIG. 9A shows an expansion of the color palette of Xa-TiO₂ coatings with representative images of Xa coatings with supplemental ultramarine blue before and after irradiation, as well as 24 hours after irradiation. Images represent approximately 400 mm² of coating surface.

FIG. 9B shows images of samples patterned with two different photochromic formulations that enable unique, simultaneous color changes. Images represent approximately 500 mm² of coating surface.

FIG. 9C shows the CIELAB color coordinate diagram depicting chromaticity values of Xa:TiO₂ coatings with and without supplemental ultramarine blue before and after irradiation.

FIG. 10A shows selective irradiation of photoresponsive Xa-TiO₂ coatings with a geometric canine profile patterned in masking tape and temporarily adhered to coating surfaces. After irradiation, the contrast of the reduced Xa pattern within the unirradiated surrounding substrate was distinctly visible, and faded toward the original color of the substrate over the course of 72 h. Scale bar represents approximately 12 mm.

FIG. 10B shows selective irradiation of photoresponsive Xa-TiO₂ coatings with a typeface symbol patterned in masking tape and temporarily adhered to coating surfaces. After irradiation, the contrast of the reduced Xa pattern within the unirradiated surrounding substrate was distinctly visible, and faded toward the original color of the substrate over the course of 72 h. Scale bar represents approximately 12 mm.

FIG. 11A shows the particle size of the larger TiO₂ used in the coating formulations with representative SEM images. Scale bar is 1 μm.

FIG. 11B shows the particle size of the smaller TiO₂ used in the coating formulations with representative SEM images. Scale bar is 500 nm.

FIG. 11C shows representative TEM images of the larger TiO₂ particles used in the coating formulations. Scale bar is 500 nm.

FIG. 11D shows representative TEM images of the smaller TiO₂ particles used in the coating formulations. Scale bar is 50 nm.

FIG. 12 shows the average particle size for the larger and smaller TiO₂ particles. Results are an average of 50 measurements and error is reported as standard deviation.

FIG. 13A shows color recovery of 1:10 samples, with representative images of the samples with a 1:10 molar ratio of Xa to larger TiO₂ particles before irradiation, after irradiation, and after a 72-hour relaxation period.

FIG. 13B shows color recovery of 1:10 samples, with representative images of the samples with a 1:10 molar ratio of Xa to smaller TiO₂ particles before irradiation, after irradiation, and after a 72-hour relaxation period.

FIG. 13C shows results for the color recovery of the sample with larger TiO₂ particles. Results are presented as the average of three formulation replicates and the error is reported as standard deviation. The red dashed lines mark where the change in hue angle is equal to 0%.

FIG. 13D shows results for the color recovery of the sample with smaller TiO₂ particles. Results are presented as the average of three formulation replicates and the error is reported as standard deviation. The red dashed lines mark where the change in hue angle is equal to 0%.

FIG. 14A shows the change in ΔE over time during color recovery of coatings with larger TiO₂ particles. The ΔE of each coating compared to the initial coating color was calculated immediately after irradiation (t=0) and over the next 72 hours. Results illustrated a decrease in ΔE over time. Results are the average of three formulation replicates and the error is reported as standard deviation.

FIG. 14B shows the change in ΔE over time during color recovery of coatings with smaller TiO₂ particles. The ΔE of each coating compared to the initial coating color was calculated immediately after irradiation (t=0) and over the next 72 hours. Results illustrated a decrease in ΔE over time. Results are the average of three formulation replicates and the error is reported as standard deviation.

FIG. 15A shows the cycling of the coating color with sunlight for the 1:100 coating formulation with larger TiO₂ particles.

FIG. 15B shows the cycling of the coating color with sunlight for the 1:100 coating formulation with smaller TiO₂ particles.

FIG. 16 shows the transmittance profile of the polyurethane matrix from 200-900 nm.

FIG. 17 shows the absorbance spectra of TiO₂ and Xa in water from 200-700 nm.

FIG. 18 shows the cyclic voltammogram of Xa at pH 7 in 0.1 M PBS electrolyte.

FIG. 19A shows the effect of addition of red colorant to the coatings. Representative images of coatings prepared with Red Dye 40 (R40) before and after 30 minutes of irradiation. The formulations are either the 1:50, (i, ii, iii) 1:100 (iv), or 1:150 (v) molar ratio of Xa to smaller particle TiO₂ formulation with the addition of 1 (i), 2.5 (ii, v), 5 (iii), or 10 (iv) microliters of 0.5% (w/w) R40. Images represent approximately 400 mm² of coating surface.

FIG. 19B shows the effect of addition of red colorant to the coatings. The CIELAB color coordinate diagram depicting chromaticity values of Xa-based coatings with supplemental non-responsive colorants before and after irradiation. In the figure legend, ultramarine is abbreviated UM and Red Dye 40 is abbreviated R40.

### DETAILED DESCRIPTION

As used herein “about” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of 35 20%, e.g., ±10%, ±5% or ±1% of a given value. It is to be understood that the term “about” can precede any particular value specified herein, except for particular values used in the Exemplification.

A description of example embodiments follows.

### Compositions

Provided herein is a composition comprising a phenoxazone or phenoxazine (e.g., xanthommatin, or a derivative or precursor thereof), and a paint matrix, wherein the phenoxazone or phenoxazine is in non-aggregated form, for example, in solution, in the composition. In some aspects, the phenoxazone or phenoxazine (e.g., xanthommatin, or derivative or precursor thereof), is uniformly distributed throughout the composition.

Also provided herein is a composition comprising a phenoxazone or phenoxazine (e.g., xanthommatin, or a derivative or precursor thereof), and a polymeric matrix, wherein the phenoxazone or phenoxazine is in non-aggregated form, for example, in solution, in the composition. In some aspects, the polymeric matrix is a paint matrix comprising a polymeric binder. In some aspects, the polymeric matrix is an epoxy resin.

Also provided herein is a composition comprising xanthommatin, or a derivative or precursor thereof, titanium dioxide, and a water-based polyurethane paint matrix. In some aspects, the xanthommatin or derivative or precursor thereof is in non-aggregated form.

In some aspects, the xanthommatin, or a derivative or precursor thereof, is dissolved in paint. In some aspects, the xanthommatin, or a derivative or precursor thereof, is dissolved in a paint matrix (e.g., paint base).

In some aspects, the paint or paint matrix is clear or white. In further aspects, the paint or paint matrix is clear. In yet further aspects, the paint or paint matrix is white.

“Phenoxazone,” as used herein, refers to a compound having the following molecular skeleton:

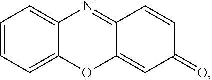 [SMILES: O=c1ccc2nc3ccccc3oc-2c1]

or a salt thereof. Examples of phenoxazones include ommatins, such as xanthommatin. In some aspects, the phenoxazone or phenoxazine is a phenoxazone, e.g., an ommatin.

“Phenoxazine,” as used herein, refers to a compound having the following molecular skeleton:

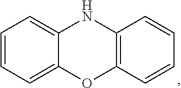 [SMILES: c1ccc2c(c1)Nc1ccccc1O2]

or a salt thereof. Examples of phenoxazines include ommins, such as ommin A. In some aspects, the phenoxazone or phenoxazine is a phenoxazine, e.g., an ommin.

In some aspects, the phenoxazone or phenoxazine is an ommochrome, e.g., an ommatin, an ommin. Ommochromes are pigments found in invertebrates, particularly crustaceans, and insects, and are thought to be synthesized in vivo from 3-hydroxykynurenine, either via uncyclized xanthommatin or by condensation of 3-hydroxykynurenine and xanthurenic acid. It is hypothesized that cyclization of uncyclized xanthommatin produces ommatins, such as xanthommatin, dihydroxanthommatin, decarboxylated xanthommatin, ommatin D, and rhodommatin, as well as ommins, such as ommin A. Ommatins are typically phenoxazones, such as pyrido-phenoxazones, while ommins are typically phenoxazines, such as phenoxazine-phenothiazines.

As used herein, “xanthommatin” refers to 11-(3-amino-3-carboxypropanoyl)-1,5-dioxo-4H-pyrido[3,2-a]phenoxazine-3-carboxylic acid. Xanthommatin and various of its precursors and derivatives can be extracted from cephalopods (e.g., squid Doryteuthis pealeii chromatophores) and other natural sources, such as the eyes, integumentary system, organs, and eggs of arthropods. Xanthommatin and its precursors and derivatives can also be synthesized using methods described herein and/or known in the art.

As described herein, the reversible change in oxidation state, with respect to xanthommatin, refers to the interchange of xanthommatin and dihydroxanthommatin:

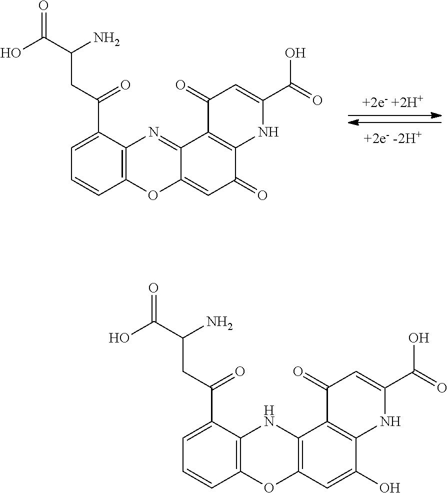 [SMILES: NC(CC(=O)c1cccc2oc3cc(=O)c4[nH]c(C(=O)O)cc(=O)c4c-3nc12)C(=O)O ; NC(CC(=O)c1cccc2c1Nc1c(cc(O)c3[nH]c(C(=O)O)cc(=O)c13)O2)C(=O)O]

As used herein, “xanthommatin, or a derivative or precursor thereof” includes synthetic precursors, such as biosynthetic precursors, of xanthommatin, as well as derivatives, such as metabolites, of xanthommatin, or a salt thereof. Precursors (e.g., biosynthetic precursors) of xanthommatin include, for example, 3-hydroxykynurenine, xanthurenic acid, and uncyclized xanthommatin. Derivatives (e.g., metabolites) of xanthommatin include, for example, dihydroxanthommatin, decarboxylated xanthommatin, ommatin C, ommatin D, rhodommatin, hydroxanthommatin, tinctoriommatin, iso-tinctoriommatin, alpha-hydroxy xanthommatin dimethyl ester, oranyeommatin methyl ester, elymniommatin, iso-elymniommatin, oranyeommatin, and a-hydroxy xanthommatin methyl ester. In some aspects, the xanthommatin, or a derivative or precursor thereof, comprises xanthommatin, dihydroxanthommatin, or xanthommatin and dihydroxanthommatin. In some aspects, the xanthommatin, or a derivative or precursor thereof, is xanthommatin, dihydroxanthommatin, or xanthommatin and dihydroxanthommatin.

Salts of the compounds described herein include salts derived from suitable inorganic and organic acids, and suitable inorganic and organic bases.

Examples of acid addition salts are salts of an amino group formed with inorganic acids such as hydrochloric acid, hydrobromic acid, phosphoric acid, sulfuric acid and perchloric acid, or with organic acids such as acetic acid, trifluoroacetic acid, oxalic acid, maleic acid, tartaric acid, citric acid, succinic acid or malonic acid or by using other methods used in the art, such as ion exchange. Other pharmaceutically acceptable acid addition salts include adipate, alginate, ascorbate, aspartate, benzenesulfonate, benzoate, bisulfate, borate, butyrate, camphorate, camphorsulfonate, cinnamate, citrate, cyclopentanepropionate, digluconate, dodecylsulfate, ethanesulfonate, formate, fumarate, glucoheptonate, glycerophosphate, gluconate, glutarate, glycolate, hemisulfate, heptanoate, hexanoate, hydroiodide, hydroxybenzoate, 2-hydroxy-ethanesulfonate, hydroxymaleate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 2-phenoxybenzoate, phenylacetate, 3-phenylpropionate, phosphate, pivalate, propionate, pyruvate, salicylate, stearate, succinate, sulfate, tartrate, thiocyanate, p-toluenesulfonate, undecanoate, valerate salts, and the like.

Salts derived from appropriate bases include salts derived from inorganic bases, such as alkali metal, alkaline earth metal, and ammonium bases, and salts derived from aliphatic, alicyclic or aromatic organic amines, such as methylamine, trimethylamine and picoline, or N⁺((C₁-C₄)alkyl)₄ salts. Representative alkali or alkaline earth metal salts include sodium, lithium, potassium, calcium, magnesium, barium and the like. Further salts include, when appropriate, nontoxic ammonium, quaternary ammonium, and amine cations formed using counterions such as halide, hydroxide, carboxyl, sulfate, phosphate, nitrate, lower alkyl sulfonate and aryl sulfonate.

Salts of 11-(3-amino-3-carboxypropanoyl)-1,5-dioxo-4H-pyrido [3,2-a]phenoxazine-3-carboxylic acid, or a derivative or precursor thereof, can be prepared from a parent compound that contains a basic or acidic moiety by conventional chemical methods. Generally, such salts can be prepared by reacting the free acid or free base form of the parent compounds with a stoichiometric amount of an appropriate base or acid, respectively, in a suitable medium, such as water, an organic solvent, or a mixture of water and an organic solvent. Typically, nonaqueous media, such as ether, ethyl acetate, ethanol, isopropanol, or acetonitrile, are preferred.

In some aspects, the phenoxazone or phenoxazine and/or xanthommatin, or a derivative or precursor thereof, is about 0.001% to about 25% weight/weight (w/w) of the composition, for example, about 0.001% to about 20% w/w, about 0.001% to about 10% w/w, about 0.001% to about 5% w/w, about 0.001% to about 2.5% w/w, about 0.001% to about 1% w/w, about 0.001% to about 0.5% w/w, about 0.01% to about 25% w/w, about 0.01% to about 20% w/w, about 0.01% to about 10% w/w, about 0.01% to about 5% w/w, about 0.01% to about 2.5% w/w, about 0.01% to about 1% w/w, about 0.01% to about 0.5% w/w, about 0.002% to about 0.9% w/w, about 0.003% to about 0.7% w/w, about 0.004% to about 0.6% w/w, or about 0.005% to about 0.55% w/w of the composition. In some aspects, the phenoxazone or phenoxazine and/or xanthommatin, or a derivative or precursor thereof, is about 0.002%, about 0.003%, about 0.004%, about 0.005%, about 0.006%, about 0.007%, about 0.008%, about 0.009%, about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, or about 1% w/w of the composition. In a preferred embodiment, the phenoxazone or phenoxazine and/or xanthommatin, or a derivative or precursor thereof, is about 0.001% to about 20% w/w of the composition. In another preferred embodiment, the phenoxazone or phenoxazine and/or xanthommatin, or a derivative or precursor thereof, is about 0.01% to about 10% w/w of the composition. In another preferred embodiment, the phenoxazone or phenoxazine and/or xanthommatin, or a derivative or precursor thereof, is about 0.01% to about 1% w/w of the composition.

In some aspects, the composition is a paint, such as a water-based paint or an oil-based paint. Both one-component paints and multi-component paint systems are within the scope of the instant disclosure. In some aspects, the composition is a one-component paint. In some aspects, the composition is a multi-component paint system.

In some aspects, the paint matrix is a paint primer matrix.

In some aspects, the paint matrix is paint base.

In some aspects, the paint matrix is a water-based paint matrix. For example, in some aspects, the paint matrix comprises a polymeric binder and an aqueous solvent, as is typical, for example, in one-component paints. In some aspects, the polymeric binder is a polyurethane, polyamide, polyester, polysaccharide, polyethylene glycol, polyacrylate or polymethacrylate. In some aspects, the polymeric binder is polyurethane. Other polymeric binders for use in water-based paint matrices are known to those of skill in the art. In some aspects, the water-based paint matrix is a water-based polyurethane paint matrix, such as a one-component, clear, water-based polyurethane paint matrix (e.g., Rust-Oleum 6711).

In some aspects, the paint matrix comprises a reactive monomer or reactive pre-polymer and an aqueous solvent, as is typical, for example, in multi-component paint systems. In some aspects, the reactive monomer or reactive pre-polymer is urethane-based, amide-based, ester-based, saccharide-based, ethylene glycol-based, acrylate-based, or methacrylate-based. In some aspects, the reactive monomer or reactive pre-polymer is urethane-based. Other reactive monomers and reactive pre-polymers for use in water-based paint matrices for multi-component paint systems are known to those of skill in the art.

In some aspects, the aqueous solvent is water. In some aspects, the aqueous solvent is or comprises a buffer. In some aspects, the aqueous solvent is or comprises a mixture of water or a buffer and an organic solvent. Examples of buffers include: acetic acid with sodium acetate, ammonium hydroxide with ammonium chloride, citric acid with sodium citrate, carbonic acid with bicarbonate, and KH₂PO₄ with K₂HPO₄. Examples of organic solvents include: alkyl solvents (such as hexanes, cyclohexane, pentanes, and the like), aromatic solvents (such as benzene, toluene, and the like), alcohols (such as methanol, acidic methanol, ethanol, and the like), esters, ethers, and ketones (such as diethyl ether, acetone, and the like), amines (such as dimethyl amine and the like), and nitrated and halogenated hydrocarbons (such as dichloromethane, acetonitrile, and the like). in a particular aspect, the aqueous solvent comprises acidic methanol.

In some aspects, the paint matrix is an oil-based paint matrix. For example, in some aspects, the paint matrix comprises an oil and a non-aqueous solvent. In some aspects, the oil is a natural oil, such as linseed oil. In some aspects, the oil is a synthetic oil, such as alkyd.

In some aspects, the non-aqueous solvent is an organic solvent. In an embodiment, the organic solvent comprises turpentine or a mineral spirit.

In some aspects, the paint matrix is greater than or about 50% w/w of the composition, e.g., greater than or about 65%, greater than or about 75%, greater than or about 80%, greater than or about 85%, greater than or about 90%, or greater than or about 95%, w/w of the composition. In some aspects, the paint matrix is less than 100% w/w of the composition, e.g., less than or about 99%, less than or about 98%, less than or about 97%, less than or about 96%, less than or about 95%, less than or about 94%, less than or about 93%, less than or about 92%, less than or about 91%, less than or about 90%, or less than or about 85%, w/w of the composition. In some aspects, the paint matrix is about 50% to less than 100% w/w of the composition, e.g., 65% to less than 100%, about 75% to less than 100%, about 75% to about 95%, about 75% to about 85%, or about 80%, w/w of the composition.

In some aspects, the composition further comprises one or more (e.g., one, two, three, four, five, etc.) additional colorants. Colorants can be used alone or in admixture to impart color(s) to a composition, such as a composition described herein. Colorants include metal oxides and other particulate pigments, and also soluble absorbers, such as dyes. In some aspects, the one or more additional colorants comprise a purple colorant, blue colorant, green colorant, yellow colorant, red colorant, black colorant, or white colorant. In some aspects, the one or more additional colorants are selected from a purple colorant, blue colorant, green colorant, yellow colorant, red colorant, black colorant, or white colorant.

In some aspects, the one or more additional colorants are or comprise a soluble dye. In some aspects, the soluble dye is selected from erioglaucine (acid blue 9) or disodium 6-hydroxy-5-[(2-methoxy-5-methyl-4-sulfophenyl)azo]-2-naphthalenesulfonate (Allura Red/Red 40).

In some aspects, the one or more additional colorants are or comprise a pigment. In some aspects, the pigment is selected from titanium dioxide, red iron oxide, yellow iron oxide, carbon black, or Prussian Blue. In some aspects, the pigment is titanium dioxide, red iron oxide, yellow iron oxide, carbon black, or ultramarine blue. For paints, such as those described herein, titanium dioxide is advantageously provided as particles having a particle size of less than about 1 micron, red and yellow iron oxides are advantageously provided as nanopowders or micron-scale particles, carbon black is advantageously provided as particles having a particle size of less than about 100 nm or aggregates, and Prussian Blue is advantageously provided as a colloidal dispersion.

Common colorants are widely available, and include, but are not limited to, colorants colored purple (e.g., ultramarine violet (Al); han purple (Cu); cobalt violet; purple of cassius (Au), etc.), blue (e.g., cobalt blue; Egyptian blue (Cu); Prussian blue (Fe); etc.), green (e.g., cadmium green; chrome green (Cr); Scheele's green (Cu); etc.), yellow (e.g., orpiment (As); primrose yellow (Bi); naples yellow (Pb); etc.), orange (e.g., bismuth vanadate orange; cadmium pigments; etc.), red (e.g., red ochre (Fe); cinnabar (Hg); burnt sienna (Fe); carmine (Al); etc.), and white (e.g., antimony white; lithopone (Ba); cremnitz white (Pb); etc.). In some embodiments, the colorant is colored blue (e.g., ultramarine blue).

In some aspects, a composition described herein further comprises an extender. Extenders are particles that are used to change the texture of paint surface to modulate specular reflectivity/gloss. Although extenders are typically pigments (often, white pigments), they are not meant to provide visible color as their primary function. Extenders typically have particle sizes of from about 100 to about 200 microns. In some aspects, the extender is diatomaceous earth, aluminate, carbonate, or silicate.

Without wishing to be bound by any particular theory, it is believed that, when included in a composition described herein, titanium dioxide operates as a photocatalyst, promoting reduction of xanthommatin upon exposure to sunlight. Thus, in some aspects, the composition further comprises one or more photocatalysts. The photocatalyst may be dissolved, dispersed, or suspended in the paint matrix. In some aspects, the photocatalyst is an inorganic photocatalyst, e.g. a photocatalyst containing one or more metal atoms. The inorganic photocatalyst may be titanium-based, magnesium-based, iron-based, tungsten-based, iridium-based, ruthenium-based, or zinc-based. In some aspects, the inorganic photocatalyst is a metal oxide. In some aspects, the inorganic photocatalyst is selected from titanium dioxide, a tungsten oxide, an iron-porphyrin complex, or a magnesium-chlorin complex. In some aspects, the photocatalyst is an organic photocatalyst, e.g. a photocatalyst without any metals. The organic photocatalyst may be disulfide-based, bipyridyl-based, benzophenone-based, phenoxazine-based, phenothiazine-based, fluorescein-based, triazine-based, acridinium-based, pyrylium-based, cyanoarene-based, trimethylarene-based or perylene-based. Examples of disulfide-based photocatalysts include: cystine and glutathione disulfide.

In some aspects, the photocatalyst has absorbance in sunlight or the UV-visible region. In some aspects, the photocatalyst has absorbance in the visible-IR region. In some aspects, the photocatalyst has absorbance in the UV region. In some aspects, the absorbance in the UV region is UVA absorbance. In some aspects, the absorbance in the UV region is UVB absorbance. In some aspects, the absorbance in the UV region is UVC absorbance. The photocatalyst may absorb light of a wavelength less than about 1 μm, about 900 nm, about 800 nm, about 700 nm, about 600 nm, about 500 nm, about 400 nm, about 300 nm, or about 200 nm.

UV light can be characterized as light having a wavelength of about 100 nm to about 400 nm. UVC light can be characterized as light having a wavelength of about 100 nm to about 280 nm. UVB light can be characterized as light having a wavelength of about 280 nm to about 315 nm. UVC light can be characterized as light having a wavelength of about 315 nm to about 400 nm. Visible light can be characterized as light having a wavelength of about 380 nm to about 780 nm. In some aspects, visible light can characterized as light having a wavelength of about 400 nm to about 700 nm. Near-IR light can be characterized as light having a wavelength of about 700 nm to about 1100 nm. IR light can be characterized as light having a wavelength of about 700 nm to about 1,000,000 nm.

In some embodiments, the one or more photocatalysts comprise titanium dioxide, advantageously, titanium dioxide microparticles or titanium dioxide nanoparticles. In some further embodiments, the one or more photocatalysts is titanium dioxide with an average particle size of less than about 500 nm, 400 nm, 300 nm, 200 nm, 100 nm, 80 nm, 60 nm, 40 nm, 20 nm, or 10 nm as measured by SEM or TEM, for example, as described in the Exemplification. In some embodiments, the titanium dioxide has an average particle size measured by SEM or TEM of less than about 150 nm. In some embodiments, the titanium dioxide has an average particle size measured by SEM or TEM of about 150 nm (e.g., 146.5 ±43.9 nm). In some embodiments, the titanium dioxide has an average particle size of less than about 50 nm, e.g., less than about 30 nm as measured by SEM, as described in the Exemplification. In some embodiments, the titanium dioxide has an average particle size of 25 nm (e.g., 24.2±5.0 nm) as measured by SEM, as described in the Exemplification.

The one or more additional colorants (e.g., soluble dye; pigment; extender) may be added in any concentration to achieve a desired effect (e.g., a desired color). In some aspects, the one or more additional colorants, taken each alone or together, are about 0.001% to about 25% w/w of the composition, e.g., about 0.001% to about 20%, about 0.001% to about 10%, about 0.001% to about 5% w/w of the composition, about 0.001% to about 1%, about 0.001% to about 0.5%, about 0.001% to about 0.1%, or about 0.1% to about 10% w/w of the composition. In some aspects, the one or more additional colorants, taken alone or together, are about 0.001% to about 9%, about 0.001% to about 8%, about 0.001% to about 7%, about 0.001% to about 6%, about 0.001% to about 5%, about 0.001% to about 4%, about 0.001% to about 3%, about 0.001% to about 2%, about 0.001% to about 1%, about 0.001% to about 0.5%, about 0.001% to about 0.05%, about 0.001% to about 0.01%, or about 0.001% to about 0.05% w/w of the composition. In some aspects, the one or more additional colorants, taken alone or together, about 0.001%, about 0.005%, about 0.01%, about 0.05%, about 0.1%, about 0.5%, about 1%, about 2%, about 3%, about 4%, about 5%, about 6%, about 7%, about 8%, about 9%, or about 10% w/w of the composition.

In some aspects, the molar ratio between xanthommatin, or a derivative or precursor thereof, and the additional colorant is from about 1:1 to about 1:1000, or about 1:1 to about 1:500, or about 1:5 to about 1:500, or about 1:5 to about 1:300, or about 1:10 to about 1:200, or about 1:10, about 1:50, about 1:100, about 1:150, or about 1:200.

In some aspects, the change in hue angle in the CIELAB color space upon irradiation of the coating with simulated solar light at 1100 W/m² for 30 minutes is at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 100% as measured with imageJ or similar software.

In some aspects, the time to relax back to the pre-irradiation hue angle following irradiation with simulated solar light at 1100 W/m² for 30 minutes is more than about 1 hour, about 2 hours, about 4 hours, about 6 hours, about 12 hours, about 18 hours, about 24 hours, about 36 hours, about 48 hours, or about 72 hours as measured with imageJ or similar software. In some aspects, the time to relax back to the pre-irradiation hue angle following irradiation with simulated solar light at 1100 W/m² for 30 minutes is less than about 1 hour, about 2 hours, about 4 hours, about 6 hours, about 12 hours, about 18 hours, about 24 hours, about 36 hours, about 48 hours, or about 72 hours as measured with imageJ or similar software. In some aspects, relaxation to half of the originally observed change in hue following irradiation with simulated solar light at 1100 W/m² for 30 minutes occurs in less than about 15 minutes, less than about 30 minutes, less than about 1 hour, less than about 2 hours, less than about 4 hours, less than about 6 hours, less than about 8 hours, less than about 12 hours, or less than about 24 hours as measured with imageJ or similar software. In some aspects, relaxation to half of the originally observed change in hue following irradiation with simulated solar light at 1100 W/m² for 30 minutes occurs in more than about 15 minutes, more than about 30 minutes, more than about 1 hour, more than about 2 hours, more than about 4 hours, more than about 6 hours, more than about 8 hours, more than about 12 hours, or more than about 24 hours as measured with imageJ or similar software.

In some aspects, the hue angle of the unirradiated coating changes less than 5% as measured with imageJ or similar software after more than 5 cycles, more than 7 cycles, more than 10 cycles, more than 20 cycles, more than 35 cycles, more than 50 cycles, more than 100 cycles, more than 200 cycles, more than 300 cycles, more than 400 cycles, or more than 500 cycles of irradiation with simulated solar light at 1100 W/m² for 30 minutes and relaxation. In some aspects, the hue angle of the unirradiated coating changes less than 2% as measured with imageJ or similar software after more than 5 cycles, more than 7 cycles, more than 10 cycles, more than 20 cycles, more than 35 cycles, more than 50 cycles, more than 100 cycles, more than 200 cycles, more than 300 cycles, more than 400 cycles, more than 500 cycles, more than 750 cycles, or more than 1000 cycles of irradiation with simulated solar light at 1100 W/m² for 30 minutes and relaxation.

In some aspects, the composition comprises one or more (e.g., one, two, three, four, five, etc.) additives. Typical paint additives and appropriate concentrations for such additives are well-known in the art. In some aspects, the one or more additives comprise a surfactant, viscosity-modifying agent, silicone, drier and/or biocidal agent. In some aspects, the one or more additives are selected from a surfactant, viscosity-modifying agent, silicone, drier, or a biocidal agent.

For example, in some aspects, the one or more additives comprise a surfactant. Examples of surfactants include sodium dodecyl sulfate (SDS), polysorbate 20 (Tween 20), polysorbate 80 (Tween 80), and Triton X-100 (2-[4-(2,4,4-trimethylpentan-2-yl)phenoxy]ethanol).

In some aspects, the one or more additives comprise a viscosity-modifying agent. Examples of viscosity-modifying agents include a xylene, polysaccharide, or hydroxyethylcellulose (HEC).

In some aspects, the viscosity-modifying agent is 0.001% to about 10% w/w of the composition, e.g., about 0.001% to about 5%, about 0.005% to about 5%, about 0.005% to about 4%, about 0.005% to about 3%, about 0.005% to about 2%, about 0.005% to about 1%, about 0.005% to about 1%, or about 0.01% to about 1%, w/w of the composition. In some aspects, the viscosity-modifying agent is about 0.001%, about 0.005%, about 0.01%, about 0.05%, about 0.1%, about 0.5%, about 1%, about 2%, about 3%, about 4%, about 5%, about 6%, about 7%, about 8%, about 9%, or about 10% w/w of the composition.

In some aspects, the one or more additives comprise a silicone. Silicones can serve a variety of functions in a composition, such as a paint, including as a wetting agent, a slip additive, a mar additive, a gloss additive, a flow and leveling additive, and a foam control agent.

In some aspects, the one or more additives comprise a drier, such as a metal-based drier. In some aspects, the metal is selected from iron, calcium, cobalt, zinc, copper, barium, or lead. In some aspects, the drier is a metal salt, such as a metal octoate.

In some aspects, the one or more additives comprise a biocidal agent, e.g., a bactericide, fungicide, or algaecide. Examples of biocidal agents include methylisothiazolinone, benzisothiazolinone, octylisothiazolinone, dichlorooctylisothiazolinone, chloromethyllisothiazolinone, butylbenzisothiazolinone, formaldehyde releasing biocides, 2-phenylphenol, zinc pyrithiones, heavy metals, cyanobutane, glutaraldehyde, 1,2 bromo-2,4 dicyanobutane, 5-chloro-2-methyl-4-isothiazolin-3-one, 2-methyl-4-isothiazolin-3-one, 2-bromo-2-nitropropane-1,3-diol, 3,5-dimethyl-2H-1,3,5-thiadiazine-2-dione, 4,4-dimethyl oxazolidine, and 1-(3-chlorally)-3,5,6-triaza-1-azoniaadamantane chloride.

In an embodiment, the one or more additives, taken alone or together, are about 0.001% to about 10% w/w of the composition, e.g., about 0.001% to about 5%, about 0.005% to about 5%, about 0.005% to about 4%, about 0.005% to about 3%, about 0.005% to about 2%, about 0.005% to about 1%, about 0.005% to about 1%, or about 0.01% to about 1%, w/w of the composition. In some aspects, the one or more additive, taken alone or together, are about 0.001%, about 0.005%, about 0.01%, about 0.05%, about 0.1%, about 0.5%, about 1%, about 2%, about 3%, about 4%, about 5%, about 6%, about 7%, about 8%, about 9%, or about 10% w/w of the composition.

In some aspects, the composition is an epoxy.

As used herein, the term “epoxy resin” refers to a family of basic components or cured end products of reactive prepolymers and polymers which contain epoxide groups. Epoxy resins may be reacted (e.g., cross-linked) either with themselves through catalytic homopolymerization, or with a wide range of co-reactants including polyfunctional amines, acids (and acid anhydrides), phenols, alcohols and thiols. Co-reactants include hardeners and curatives. Examples of polymers or prepolymers suitable for producing epoxy resins include, but are not limited to, diglycidyl ether bisphenol A, diglycidyl ether bisphenol F, tetraglycidyl methylene dianiline, diglycidyl ester of hexahydrophthalic acid, 3,4-epoxycyclohexylmethyl-3′,4′-epoxycyclohexane, triglycidyl p-amino-phenol, hydrogenated bisphenol-A epoxy resins, brominated resins produced from tetrabromo bisphenol-A, diglycidyl ether of bisphenol-F, diglycidyl ether of bisphenol-H, diglycidyl ether of bisphenol-S, diglycidyl ester of hexahydrophthalic acid, and 3,4-epoxycyclohexylmethyl-3′,4′-epoxycyclohexane.

### Uses

The disclosed compositions are unique in that they incorporate pigment(s) imparting dark color(s) (e.g., red, brown), without influencing the thermal performance of the paint as conventional pigments do. This is achieved, in some aspects, by distributing xanthommatin, or a derivative or precursor thereof, (e.g., as a solution or suspension) throughout a paint matrix. Chemical properties (e.g., oxidation state) of the phenoxazone or phenoxazine and/or xanthommatin, or a derivative or precursor thereof, can be controlled to augment or tune visible color while minimizing impact on the thermal performance of a given coating system. Thus, the disclosed compositions are useful for modulating the color and/or thermal properties of a surface.

Provided herein is a method for modulating the color or thermal properties or both of a surface, the method comprising applying a composition described herein to the surface, or a portion thereof, thereby forming a coating of the composition on the surface, or a portion thereof. In some aspects, the method is for modulating the color of a surface. In some aspects, the method is for modulating the thermal properties of a surface. In some aspects, the method is for modulating the color and thermal properties of a surface.

Modulating thermal properties of a surface includes modulating actual temperature of the surface or a volume formed at least in part by the surface, and modulating perceived temperature (e.g., observed, as by measurement) of the surface or a volume formed at least in part by the surface. In some aspects, the method modulates the actual temperature of the surface or a volume formed at least in part by the surface (e.g., a structure, flat surface, or vehicle). In some aspects, the method modulates the perceived temperature of the surface or a volume formed at least in part by the surface (e.g., a structure, flat surface, or vehicle).

The compositions can be applied (e.g., in accordance with the methods described herein) to any surface that can be painted. Thus, in some aspects, the surface is a structure, a flat surface, or a vehicle (e.g., motorized vehicle). Examples of structures include, but are not limited to, skyrises and other buildings, houses, playground equipment, deployable structures (such as tents, research centers, field hospitals, and other temporary structures), gazebos, sheds, and the like. Examples of flat surfaces include, but are not limited to, a roof or wall surface, a sidewalk surface, a fence surface, a road surface, and the like. Examples of vehicles include, but are not limited to, airplanes, cars, trucks, commercial vehicles, and the like. In some aspects, the flat surface is an asphalt surface, a sidewalk surface, a fence surface, or a road surface. Use of the compositions described herein on flat surfaces in areas, such as a city, may help reduce the urban heat island effect.

The compositions can be applied (e.g., in accordance with the methods described herein) to a surface using any technique for applying paint. In addition, the compositions can be applied in a single coat or multiple coats (e.g., two, three, four, five, etc. coats), which, taken alone or together, form the coating in the methods described herein. In some aspects, applying comprises spraying, brushing, or rolling the composition onto the surface, or a portion thereof. In preferred aspects, the composition is sprayed onto a surface or portion thereof.

In some aspects, a coating has a thickness of less than about 1 mm, e.g., less than about 500 μm or less than about 100 μm. In some aspects, a coating has a thickness of from about 250 μm to about 500 μm.

In some aspects, the method further comprises drying the coating. The coating can be dried, for example, as by air-drying, dehumidifying the surrounding air, or applying warm or hot air to the coating.

Also provided herein is a method for modulating the color or thermal properties or both of paint or a paint matrix, comprising dissolving a phenoxazone or phenoxazine (e.g., xanthommatin, or a derivative or precursor thereof), in the paint or paint matrix in an amount sufficient to achieve about 0.001% to about 20% w/w of the xanthommatin, or a derivative or precursor thereof. Also provided herein is a method for modulating the color or thermal properties or both of paint or a paint matrix, comprising dissolving xanthommatin, or a derivative or precursor thereof, in the paint or paint matrix in an amount sufficient to achieve about 0.001% to about 20% w/w of the xanthommatin, or a derivative or precursor thereof.

In some aspects, the method is for modulating the color of paint or a paint matrix. In some aspects, the method is for modulating thermal properties of paint or a paint matrix. In some aspects, the method is for modulating color and thermal properties of paint or a paint matrix. In some aspects, the method is for modulating the color of paint or a paint matrix in response to light, e.g. sunlight. In some aspects, the method is for modulating the color of paint or a paint matrix in response to light of a wavelength less than about 1 μm, about 900 nm, about 800 nm, about 700 nm, about 600 nm, about 500 nm, about 400 nm, about 300 nm, or about 200 nm.

### Method of Making

The compositions described herein can be prepared according to the examples provided. As will be appreciated by the skilled artisan, preparation of the compositions is not limited to the examples. The compositions can be prepared by alterations to the examples provided or by alternative processes. The processes described herein can be used to produce the compositions described herein in milligram scale, gram scale, kilogram scale, or greater.

Provided herein is a method for making a composition (e.g., a paint, such as a water-based paint), such as composition described herein, comprising dissolving a phenoxazone or phenoxazine in a paint matrix in an amount sufficient to achieve about 0.001% to about 20% weight/weight (w/w) of the phenoxazone or phenoxazine in the composition. Also provided herein is a method for making a composition (e.g., a paint, such as a water-based paint), such as composition described herein, comprising dissolving xanthommatin, or a derivative or precursor thereof, in a paint matrix in an amount sufficient to achieve about 0.001% to about 20% weight/weight (w/w) of the xanthommatin, or a derivative or precursor thereof, in the composition. A person skilled in the art can select an appropriate amount of phenoxazone or phenoxazine and/or xanthommatin, or a derivative or precursor thereof, to achieve the desired weight percentage in the composition. Examples of weight percentages include any of those described herein.

As is described herein, a phenoxazone or phenoxazine and/or xanthommatin, or a derivative or precursor thereof, can conveniently be dissolved, particularly in water-based paint matrices, by providing the phenoxazone or phenoxazine and/or xanthommatin, or a derivative or precursor thereof, as a solution or suspension. Thus, in some aspects, the method comprises combining an aqueous solution or suspension of phenoxaxone or phenoxazine and/or xanthommatin, or a derivative or precursor thereof, with a water-based paint matrix miscible with the aqueous solution or suspension, thereby dissolving the phenoxazone or phenoxazine and/or xanthommatin, or a derivative or precursor thereof, in the paint matrix.

When the phenoxazone or phenoxazine and/or xanthommatin, or a derivative or precursor thereof, is soluble in a paint matrix, as is the case, particularly with water-based paint matrices, then the phenoxazone or phenoxazine and/or xanthommatin, or a derivative or precursor thereof, can also or alternatively be provided in solid form. In some aspects, the method comprises adding solid phenoxazone or phenoxazine and/or xanthommatin, or a derivative or precursor thereof, to a water-based paint matrix, thereby dissolving the phenoxazone or phenoxazine and/or xanthommatin, or a derivative or precursor thereof, in the paint matrix.

In some aspects, the process further comprises mixing the composition to uniformly distribute the phenoxazone or phenoxazine and/or xanthommatin, or a derivative or precursor thereof, throughout the composition. Mixing can be accomplished, for example, by stirring, shaking, vortexing, sonicating, etc.

### EXEMPLIFICATION

A class of bio-derived, environmentally safe, and unique light scattering pigments derived from cephalopod skin is reported. A synthetic form of the cephalopod pigment xanthommatin (Xa) is used herein in formulations to create robust spray-processable coatings. The application of this specific class of processable pigments provides enhanced absorption of a broad spectrum of visible light and provides greater color fidelity within thin (e.g., <100 μm) form factors. The utility of these custom-formulated materials as environmentally friendly or “green”, enhanced coatings and their ability to provide variations in visible color schemes while maintaining a low ESOH risk that not only increases user safety but also minimizes environmental impact has resulted in a new class of sustainable coatings.

Cephalopods, including, for example, squid, cuttlefish, and octopus, represent biological models for flexible displays. They can undergo rapid and adaptive coloration, enabled principally by the areal expansion and retraction of pigment sacs, without a loss of color fidelity, all within a conformable skin. The robust optical properties of cephalopod (e.g., squid) chromatophores make them a compelling platform for the bio-inspired design of new types of pigments and photonic granules for coatings.

The natural, color modulating features of squid pigments (e.g., xanthommatin) have now been translated into deployable spray-coating systems that enable broad spectral properties on multiple material platforms (e.g., hard substrates, plastics, and/or soft fabrics). Initially, a range of formulations that are stable under different environmental conditions (e.g., are temperature- and humidity-independent). Solutions and suspensions of pigments were designed and tested across hundreds of different substrates. Part of this work included optimization of formulations that are material specific and the assessment of coating performance and (weather) durability as a function of formulation. Visible assessments were used to monitor color and color uniformity.

Preparation and application of xanthommatin-based paints. The primary pigment in the paint formulation, xanthommatin, can be prepared synthetically according to previously described protocols or extracted from the tissues of animals (e.g., cephalopods). To prepare xanthommatin-based paints, solutions of pigment dissolved in an aqueous (e.g., MES buffer) or organic (e.g., acidic methanol) carrier liquid can be blended/mixed with standard paint matrices, such as water or oil-based paint matrices, that are miscible with the selected carrier. Surfactants or other dispersing agents may be added to the mixture to stabilize the final paint composition. If the pigment is soluble in the binder system, which is the case with some paint products, then solid xanthommatin may be added directly to the paint matrix without being dissolved in a compatible carrier liquid.

In some embodiments, oxidized xanthommatin is combined with a water-based polyurethane clear coat using water, in which the pigment is only slightly soluble, or MES buffer, in which the pigment is fully soluble, as carrier liquids. It has been determined that xanthommatin is soluble in this binder matrix, so both of these formulation approaches provide the pigment in its molecular form, not as particles, uniformly distributed throughout the formulation and, ultimately, an applied coating. Because this approach uses soluble xanthommatin molecules, it is fundamentally different from the work described in International Publication No. WO 2019/139659, where xanthommatin-based particles of a specific size are used.

The visible color of the paint is controlled via the concentration of xanthommatin in the paint formulation. Xanthommatin has also been blended with traditional particulate/solid pigments (e.g., Prussian Blue) to create additional colors (e.g., green). These paints are currently applied by spraying but may also be brushed or rolled onto a surface depending on the needs of the user.

Paint performance. A variety of visible colors can be achieved by controlling the oxidation state of xanthommatin and blending with other pigments. Xanthommatin alone, when fully dissolved in the paint matrix as a “liquid pigment,” imparts visible color to painted surfaces. Because xanthommatin can be directly incorporated into existing paint systems by mixing, important properties of the paint base (e.g., dry time, hardness, sheen) are retained if desired colors can be achieved without adding liquid xanthommatin carriers (e.g., paint thinners) beyond the limits of manufacturer's specifications. For the water-based polyurethane formulations detailed here, dilution of the paint matrix upon addition of xanthommatin can be kept within the manufacturer's recommended limit (e.g., 5%) because the pigment is fully soluble in the binder.

### Example 1

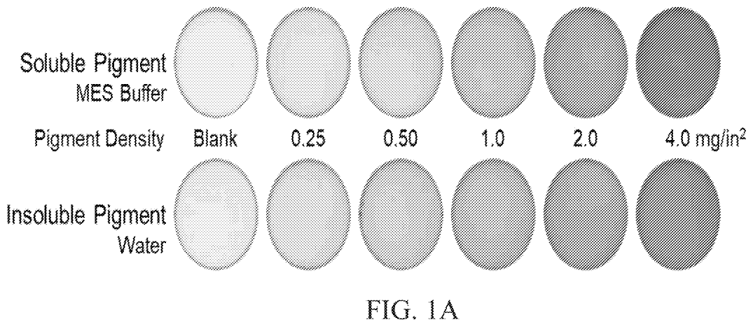

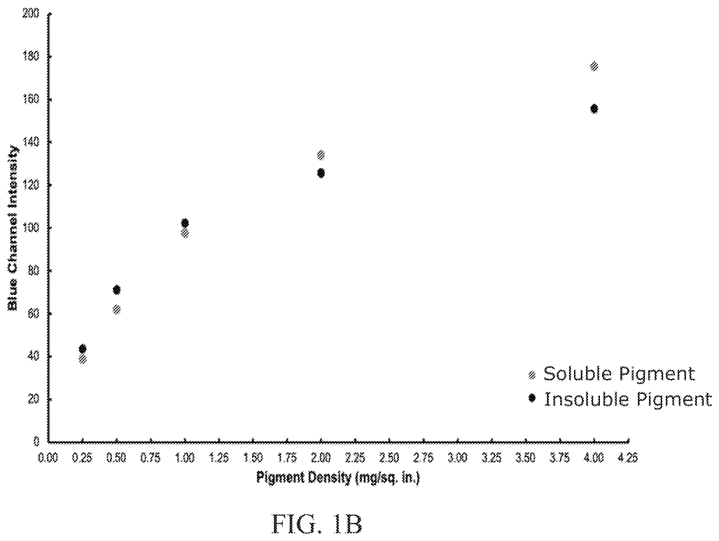

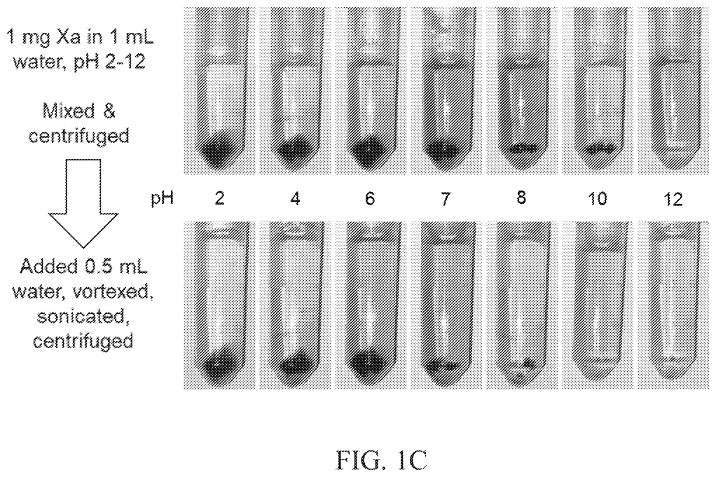

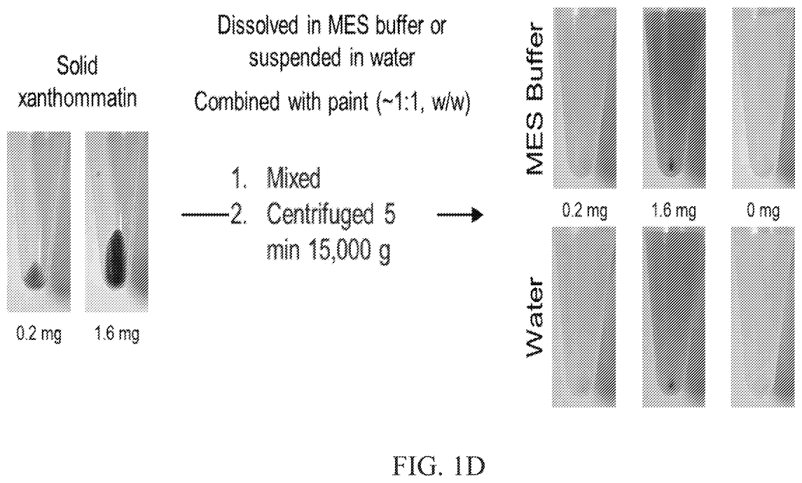

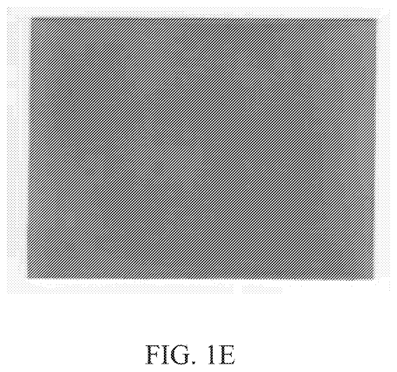

Formulation of and application of bio-inspired paints: Xanthomattin, prepared by oxidative cyclization of the precursor 3-hydroxykynurenine, was dissolved in 2-(N-morpholino) ethanesulfonic acid (MES) buffer (0.1 M, pH 5.5) or dispersed in deionized water. These mixtures were added to water-based polyurethane paint (Rust-Oleum 6711) to create 0.3 g samples containing quantities of xanthommatin corresponding to 0.026, 0.051, 0.102, 0.205, and 0.409% (w/w) xanthommatin. For each paint sample, the final formulation was 90% polyurethane and 10% pigment plus carrier fluid (either water or MES buffer) by mass. These samples were airbrushed onto a white paper test card (Leneta) through circular masks (0.307 square inches, ⅝ inch diameter) to obtain coatings with approximate pigment densities of 0.25, 0.5, 1.0, 2.0, and 4.0 mg per square inch. Samples were allowed to dry overnight, and were imaged using a flatbed scanner (600 dpi) (FIG. 1A). The RGB pixel intensity of painted circles in each image was measured using ImageJ, and blue channel values were used to track the relationship between pigment density and color richness (FIG. 1B).

Evaluation of pH-dependent xanthommatin solubility: Fractions of solid xanthommatin corresponding to 1 mg of starting material were dispersed in 1 mL of filtered water adjusted to pH 2.01, 4.00, 6.00, 7.00, 8.01, 10.01, or 12.00. Samples were mixed by pipetting, centrifuged at 15,000 g for 5 minutes, and imaged with a camera to record the mass of undissolved material (FIG. 1C, top panel). Each sample was then diluted to 1.5 mL with water adjusted to its respective pH, mixed by vortexing, sonicated for 5 minutes, centrifuged at 15,000 g for 5 minutes, and imaged again (FIG. 1C, bottom panel).

Evaluation of xanthommatin solubility in water-based polyurethane: Two quantities of solid xanthommatin, corresponding to either 0.2 or 1.6 mg of xanthommatin, were dissolved or dispersed in 0.3 mL of MES buffer (0.1 M, pH 5.5) or deionized water, and added to 0.27 g fractions of water-based polyurethane paint (Rust-Oleum 6711). Pigment-free samples were prepared as controls. After mixing, these samples were centrifuged (15,000 g, 5 minutes), and imaged using a camera (FIG. 1D).

Color blending to create green color: Prussian Blue (iron(III) hexacyanoferrate(II)) was prepared by mixing equal volumes of 1 M potassium ferricyanide and 1 M iron(II) sulfate heptahydrate, washing the resulting blue precipitate with DI water, and drying over desiccants. After drying, small quantities of solid Prussian Blue (e.g., 5% (w/w)) can be blended into paints containing xanthommatin to obtain green colors (as represented by FIG. 1E).

### Example 2

Pigment synthesis: Xanthommatin (Xa) was synthesized via the cyclization of 3-hydroxykynurenine according to previous procedures. The initial “small” prototyping scale, 3-hydroxykynurenine (0.036 mmol, 1.00 equiv) was suspended in 1.5 mL deionized (DI) H₂O and dissolved by 5 additions of 1 M NaOH (10 μL per addition). Next, DI H₂O was added to reach a total volume of 2 mL. Potassium ferricyanide (0.100 mmol, 2.78 equiv) was next dissolved in 1 mL DI H₂O and added dropwise to the 3-hydroxykynurenine solution. The reaction was covered to exclude light and stirred at room temperature for 1.5 hours. The product was precipitated using 1 mL of 1 M hydrochloric acid, washed 3 times with chilled DI H₂O, and stored at 4° C.

Supplementary dye selection: Formulations containing Xa were developed and diversified upon application of the following commercially available “eco-friendly” pigments and dyes. While colors with all of the materials listed in Table 1 were tested, only ferric oxide, titanium (IV) dioxide, and Prussian blue were used in final formulations.

TABLE 1
Additional eco-friendly pigments and dyes

| | | | | Final |
|---|---|---|---|---|
| Name | Chemical Formula | CAS No. | Size | Use |
| Ferric Oxide | Fe₂O₃ | 1309-37-1 | N/A | Yes |
| Titanium (IV) Dioxide | TiO₂ | 13463-67-7 | N/A | Yes |
| Prussian Blue | Fe₄^{III}[Fe^{II}(CN)₆]₃ | 14038-43-8 | Colloidal | Yes |
| Acid Blue 9 | C₃₇H₃₄Na₂N₂O₉S₃ | 3844-45-9 | Soluble | No |

Paint and primer selection: The following the following paint and primer selection were used in prototyping the coatings. After a series of trials, a water-based polyurethane carrier solution (Rust-Oleum) and the SW MIL-DTL-53022F Type IV primer was used. The primers used were white or off-white, non-proprietary background colors.

TABLE 2
Paints and primers

| | | | Final |
|---|---|---|---|
| Brand | Product Name | Use | Use |
| Rust-Oleum | 6711 System Clear Water-Based | Pigment | Yes |
| | Polyurethane | carrier | |
| Sherwin Williams | MIL-DTL-53022F Type IV | Primer | Yes |
| Sherwin Williams | MIL-DTL-53030D Type II | Primer | No |
| Sherwin Williams | Resilience Ultra Deep Base (Flat) | Primer | No |

Final formulations: Blending Xa in combination with conventional environmentally safe pigments (e.g., TiO₂, red/yellow iron oxides) to diversify color palette was explored. Table 3 provides a list of final formulations and their associated visible colors. All formulations were diluted with DI H₂O to reach a final weight % (wt %) of 100.

TABLE 3
Percent compositions for diverse color palette

| Material | Sandstone | Tan | Sand 1 | Desert 2 | Yellow |
|---|---|---|---|---|---|
| Xa | 0.04 wt % | 0.04 wt % | 0.04 wt % | 0.04 wt % | 0.04 wt % |
| Fe₂O₃ | — | 0.007 wt % | — | 0.03 wt % | 0.01 wt % |
| TiO₂ | 0.05 wt % | 0.08 wt % | 0.07 wt % | 0.05 wt % | 0.08 wt % |
| Prussian | 0.003 | 0.003 | 0.007 | 0.003 | |
| Blue | wt % | wt % | wt % | wt % | |
| Rust- | 80 wt % | 80 wt % | 80 wt % | 80 wt % | 80 wt % |
| Oleum | | | | | |

Spray coating: Samples of the compositions described in Table 3 were spray coated using an airbrush or HVLP spray gun. For initial prototyping, 1×1 in swatches were sprayed using the following spray equipment: Master Airbrush Model G233 (0.5 mm fluid needle and tip set) and BINKS (Model #98-3170) 12.0 cmf @30 psi HVLP Spray Gun Kit.

Testing: The color (RGB values and reflectivity/transmittivity values) were analyzed as a function of percentage of total pigment as measured by Perkin Elmer Lambda 900 UV/Vis/NIR Spectrometer with an integrating sphere accessory.

Environmental testing was conducted, where paints swatches were subjected to “Basic Cold” and “Basic Hot” of MIL-STD 810H. The control samples showed some yellowing after environmental stress, suggesting that the primer only shows some color breakdown. This observation is not entirely uncommon, as many commercially available clear coats/paints experience some “browning” effects after environmental stress.

Conclusions: A new suite of topcoat paints with <1% human-safe and environmentally friendly colorants in a water-based polyurethane (Rust-Oleum 6711) have been developed. Incorporation of Rust-Oleum not only eliminates the need for two-part paint systems, but also eliminates abundance of free isocyanates inherent in these systems.

### Example 3. Dynamic, Bio-Inspired Colorants for Solar-Activated Color-Changing Paints

Solar activated paint that can undergo reversible changes in visible color in response to sunlight have been developed. These coatings utilize the previously discovered photochemical properties of xanthommatin (Xa), the primary colorant in cephalopod skin that enables camouflage and other forms of visual signaling. In cephalopod skin, Xa is found in a variety of colors corresponding to the oxidation state of the molecule. The oxidized form of Xa is yellow and the reduced form is red. Recently, it was discovered that Xa can undergo redox transitions in response to sunlight. Xa-based paint formulations have been developed that can undergo reversible photochemical changes, starting with Xa in the oxidized state and shifting toward the reduced state upon irradiation, to create transient changes in visible color that can last up to eight hours post-irradiation.

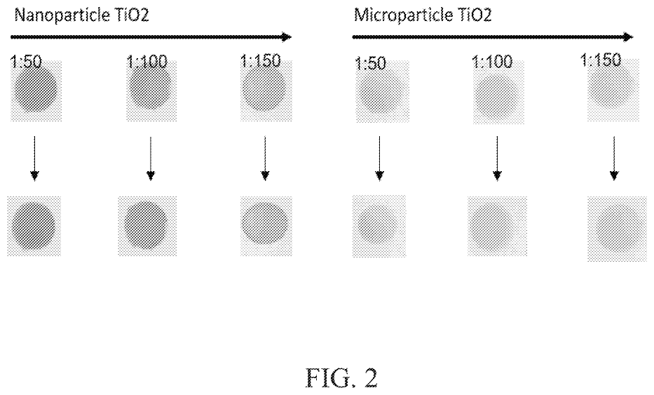

To create prominent hue shifts in solar-activated Xa-based paints, titanium dioxide (TiO₂) was added to the formulations. Without wishing to be bound by any particular theory, it is noted that TiO₂ is a known photo-catalyst and may assist the electron transfer during redox changes in Xa. Because reactions between TiO₂ and Xa occur at or near the surfaces of the TiO₂ particles, coating formulations were created with controlled TiO₂ particles sizes to determine how these two materials interact to control visible color. A nanopowder TiO₂ was selected with the rationale that a higher accessible surface area would create more opportunities for TiO₂-enhanced photoreduction. It was found that TiO₂ nanoparticles created much more pronounced shifts in paint color upon irradiation compared to formulations containing TiO₂ microparticles (FIG. 2). Additionally, it was found that the molar ratio of Xa and TiO₂ incorporated into these paint formulations dictates the accessible hues of the coatings before and after irradiation.

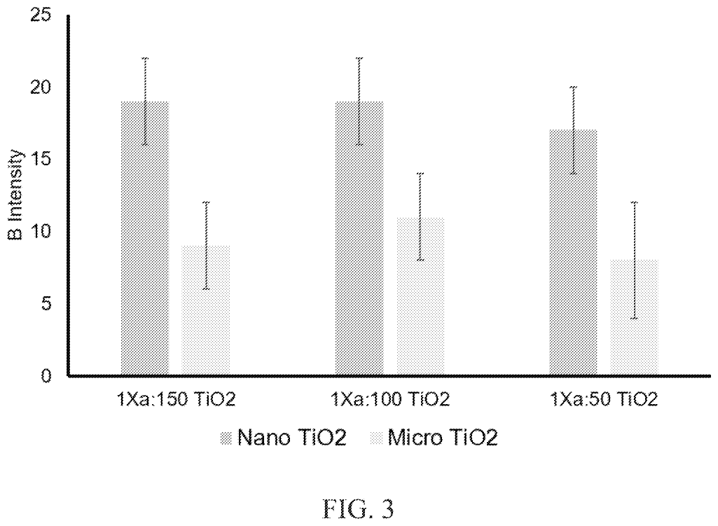

Image analysis was used to measure the visible responses of the coatings to solar light. For the xanthommatin-based paints, hue shift caused by irradiation were best captured by the blue channel of RGB pixel intensity measurements of images of the samples. After one hour of irradiation of three different coating compositions with simulated solar light, larger changes (e.g., 20 units) were observed in blue channel pixel intensity for formulations containing TiO₂ nanoparticles versus microparticles (FIG. 3).

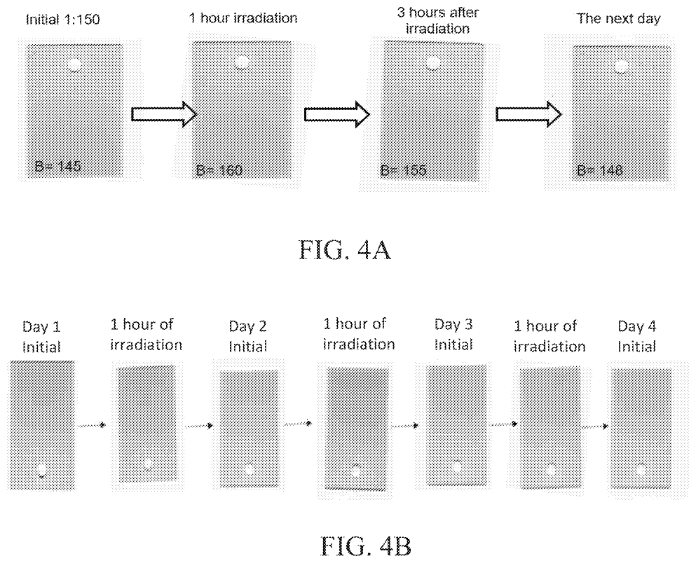

Across all of these formulations, it was observed that radiation-driven color change is reversible. The timescale of passive re-oxidation of Xa was much longer (e.g., greater than about 6 hours) than photoreduction by solar light (FIG. 4A). In testing the durability and functional lifetime of these coatings, it was observed that they remain functional and do not fade over four cycles of photoreduction (FIG. 4B).

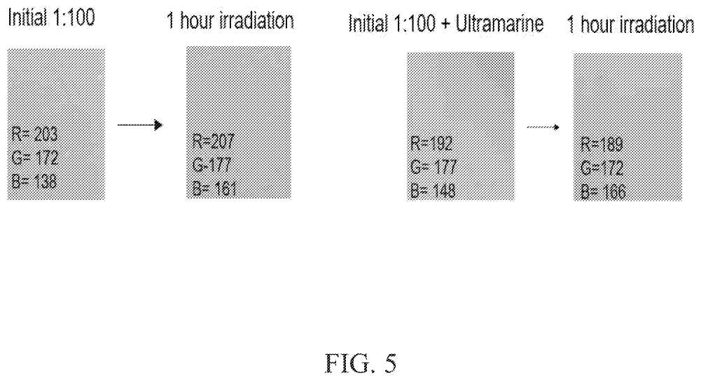

Blending conventional colorants (e.g., soluble dyes or particulate pigments) into these formulations to broaden the accessible color palette of the color-changing paints was also explored. For example, blending a static blue colorant into these formulations could shift the color of the initial, unirradiated paint toward green, and blend with the red color of photo-reduced Xa to create a more purple hue than what is observed in the standard formulation. Adding ultramarine, a natural blue particulate pigment, to a 1:100 Xa: TiO₂ coating formulation shifted the RGB values of the coating pre and post-irradiation (FIG. 5), demonstrating that the dynamic function of Xa in these color-changing systems can be blended with conventional, accessible materials to expand the color palette of the coating system.

A solar-activated, color-changing paint based on xanthommatin, a natural and photo-responsive pigment, has been developed. Previous evaluations of xanthommatin have uncovered a radiation-controlled switch from the oxidized form to the reduced form of xanthommatin, resulting in a visible color change from yellow to red. This unique functional material was coupled herein with titanium dioxide, a known photo-catalyst, to create paint formulations that can change color when exposed to sunlight. Unirradiated samples are tan owing to the combination of oxidized xanthommatin (yellow) and TiO₂ (white), while irradiation shifts xanthommatin to its reduced state (red), resulting in a pink-red color. It was noted that these color changes can be controlled by the molar ratio of xanthommatin and TiO₂ in the paint, as well as the size and surface area of TiO₂ particles. The paint is responsive to sunlight, presenting visible color changes within one hour and slowly returning to the original state over a period of six hours or more, meaning that these coatings could provide changes in color that last longer than existing photochromic molecules and are less sensitive to changes in ambient lighting. These formulations have been tested on samples ranging from one to four square inches, but it is believed that they could be scaled to cover larger surface areas.

Solar paint fabrication: Nanometer or microparticle TiO₂ (Sigma Aldrich) were mixed into a measuring cup with clear water-based polyurethane paint and synthesized xanthommatin. This solution was mixed before being placed in a capped centrifuge tube. The centrifuge tube was vortexed for one minute and then sonicated for 10 minutes. This process was repeated three times to fully mix the paint. A spray gun was then used to evenly spray the paint mixture on to a small steel substrate coated with a white primer layer. Three coats were evenly sprayed and allowed to dry. All samples were left to dry overnight and were ready for use the next day. To test the color change of the substrates, they were placed under a solar lamp of 1000+W/m² (400-1100 nm) for 60 minutes. Scans (600 dpi) of samples before and after irradiation were analyzed for RGB pixel intensity to track photoreduction and re-oxidation.

Example Advantages of the solar-activated color-changing paints include:
Color persistence: Induced color change reverses slowly after irradiation; materials do not have to be under continuous irradiation to maintain desired effect for several hours;
Low power: These paints requires no external energy source other than the sun; and/or
Durability/Lifetime: Color changes are reproducible and paints do not fade, highlighting the possibility for a long functional service life on painted surfaces.

Example Uses of the solar-activated color-changing paints include:
Color-changing displays and art: Advertisements or messaging that are weather-dependent (sun versus clouds), or follow predictable cycles over time (sunrise to sunset);
Sensing: Painted surfaces that report irradiation dose via colorimetric signals;
Consumer goods: Novelty items, toys, beauty products (e.g., nail polish), accessories (e.g., sunglasses);
Dynamic coatings for consumer-focused applications; and/or
Light sensing and/or dosimetry.

### Example 4. Color-Changing Paints Enabled by Photoresponsive Combinations of Bio-Inspired Colorants and Semiconductors

Abstract: Modern paints and coatings are designed for a variety of applications, ranging from fine art to extraterrestrial thermal control. These systems can be engineered to provide lasting color, but there are a limited number of materials that can undergo transient changes in their visual appearance in response to external stimuli without requirements for advanced fabrication strategies. Described herein are color-changing paint formulations that leverage the redox-dependent absorption profile of xanthommatin, a small-molecule colorant found throughout biology, and the electronic properties of titanium dioxide, a ubiquitous whitening agent in commercial coatings. This combination yields reversible photoreduction upon exposure to sunlight, shifting from the oxidized (yellow) form of xanthommatin, to the reduced (red) state. The extent of photoreduction is dependent on the loading density and size of titanium dioxide particles, generating changes in hue angle as large as 77% upon irradiation. These coatings can be blended with non-responsive supplemental colorants to expand the accessible color palette, and irradiated through masks to create transient, disappearing artwork. These formulations demonstrate energy-efficient photochromism using a simple combination of a redox-active dye and metal oxide semiconductor, highlighting the utility of these materials for the development of optically dynamic light-harvesting materials.

Introduction: For more than 100,000 years, natural materials have been incorporated into paints and coatings for decoration and protection. From rudimentary combinations of naturally available colorants including ochre, bone ash, calcite, charcoal, and lapis lazuli, blended into animal fat and oils to engineered coatings featuring synthetic pigments, paints are versatile tools for applications ranging from prolonging the service lifetime of buildings and infrastructure to design and self-expression. In modern formulation science, precise combinations of natural and synthetic materials, including pigments, soluble dyes, dispersing agents, and supplemental additives (e.g., fillers, extenders, and texture control agents) are employed to achieve target color and gloss values in a wide variety of paint matrices (e.g., synthetic and natural resins, lacquers, thermosetting systems). A broad abundance of compatible ingredients enables targeted design of paints with well-controlled optical properties tailored toward application-specific durability and performance requirements. These paints can typically maintain their original color and sheen over long time periods (e.g., 10 years) before re-application is necessary.

While color fastness is an advantage in many commercial and industrial applications, a growing number of responsive materials have been developed to create coating formulations that can undergo changes in response to their surroundings or an applied stimulus. Broadly, these include electrochromic materials (e.g., PEDOT: PSS, 4,4′-bipyridinium salts, tungsten oxide) that can provide dramatic changes in light transmittance in response to an applied voltage, films comprised of arrayed particles or other patterned features that undergo changes in size and structural coloration in response to vapor adsorption, ion deposition, or mechanical manipulation, and thermochromic or photochromic dyes that undergo reversible changes in their chemical structure (e.g., cis-trans isomerization, ring opening/closure) upon exposure to heat or light, respectively. For each of these classes of materials, the source of input energy required to drive specific optical changes is an important consideration in the design of integrated and scalable technologies, where performance features (e.g., switching speed) and the accessible color palette are directly linked to color-changing materials and their activation thresholds. For example, while electrochromic devices can change color within milliseconds, integration of control circuitry and multilayered device requires multi-step fabrication strategies. Materials that provide dynamic structural coloration are resistant to photobleaching and can be tuned to provide broad color palettes but often must be directly accessible by controlling species in their surroundings, which may limit the durability of these systems over time in harsh or extreme environments. Both thermochromic and photochromic materials can be embedded or encapsulated in a durable bulk matrix, such as paint. While the leuco dyes and liquid crystal materials that enable thermochromic performance offer reproducible color switching, these formulations can require substantial energy from an outside source to function. In cases where localized heating (e.g., 25 to 80° C.) is not practical, ambient sources of energy, such as sunlight, can be a preferred strategy to enable responsive color change across a variety of environments.

Material combinations that leverage natural functional materials and mechanisms are among the most energy-efficient formulations that can undergo optical and mechanical changes upon exposure to light, as they can be tuned to respond to the ambient energy of the sun. Examples of bio-inspired photoresponsive materials include self-cleaning membranes, actuators that bend toward light via photothermal and optomagentic mechanisms, and color-changing hydrogel formulations. Interestingly, materials typically incorporated into paint and coating systems can catalyze alterations of light-absorbing materials in the presence solar radiation. For example, titanium dioxide (TiO₂), a ubiquitous pigment used to hide the underlying substrate and control brightness in nearly all commercially available paint formulations, can catalyze destruction of organic dyes in response to increasing doses of sunlight. This approach highlights opportunities to control natural colorants by leveraging the electronic properties of inorganic materials in solid-state formulations. The color-changing natural colorant xanthommatin (Xa), the primary pigment in the skin of arthropods and cephalopods, can undergo pH-regulated color changes in response to sunlight to enable colorimetric measurements of solar exposure. The redox-dependent color of Xa can also be controlled electrochemically, indicating that transient changes in the optical properties of this natural colorant may be controlled using combinations of environmentally-friendly semiconductors and sunlight.

Disclosed herein is the development of photochromic coating formulations that reversibly shift between the oxidized (yellow) and reduced (red) states of Xa in response to solar radiation. Incorporation of Xa into a water-based polyurethane paint matrix with TiO₂, a known photocatalyst, of two different particle sizes promotes Xa reduction upon exposure to sunlight. The spray-processible paint samples were prepared with different molar ratios of Xa to TiO₂, and measured for dose-dependent color change, relaxation toward pre-irradiation color in the absence of sunlight, and reversibility of light-driven color change over multiple cycles of irradiation and relaxation. To more closely examine the spectral contributions that enable this color change observed color changes, samples were exposed to UVA, UVB, UVC, and visible/IR light individually and the intensity of resulting color changes examined. Additionally, the color palette of the coatings was expanded by blending combinations of Xa and TiO₂ with non-photoresponsive supplement colorants. Finally, selective irradiation of geometric designs onto coated samples demonstrated formation of complex, contrasting patterns that disappear over time.

### Results and Discussion

Irradiation Experiments: In this work, Xa was used as a colorant in water-based polyurethane coatings to explore its color changing abilities under sunlight when embedded in a solid paint matrix. To quantify color changes in the coating, hue angle was measured before and after irradiation (Equation 1). A color's hue is generally defined as how similar the color is to red, yellow, blue, green, or a combination of two of those colors. In the CIELAB color space, hue angle is the angle between the a (red to green) and b (yellow to blue) axes. This value provided a strong indication as to how the overall color of the coatings changed in response to irradiation, as opposed to changes in single components of overall color (e.g., RGB color channels). When exposing coatings consisting solely of Xa in the polyurethane matrix to 1100 W m⁻² sunlight for 60 minutes, hue angle changes of 2.7±0.4% (63.5±0.6° to 65.2±0.4°)were observed, indicating almost no change from the initial color of the sample. The only observable change was a slight darkening of the coating. Coatings prepared from the polyurethane matrix alone were also evaluated, which produced minimal color change due to sunlight, indicating that hue shifts in Xa-containing coatings were not due to alterations of the polyurethane paint base (Table 4).

TABLE 4
The hue angle of the coatings without TiO₂ before and
after 60 minutes of irradiation.

| | Hue Angle Before | Hue Angle After | Change in Hue |
|---|---|---|---|
| Sample | Irradiation | Irradiation | Angle |
| Polyurethane | −83.3 ± 0.2° | −81.6 ± 0.5° | 2.0 ± 0.5% |
| Polyurethane and Xa | 63.5 ± 0.6° | 65.2 ± 0.4° | 2.7 ± 0.4% |

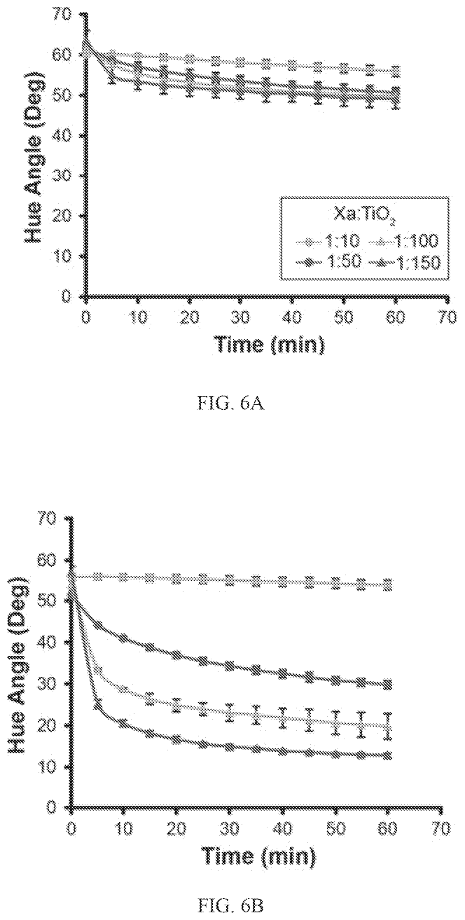

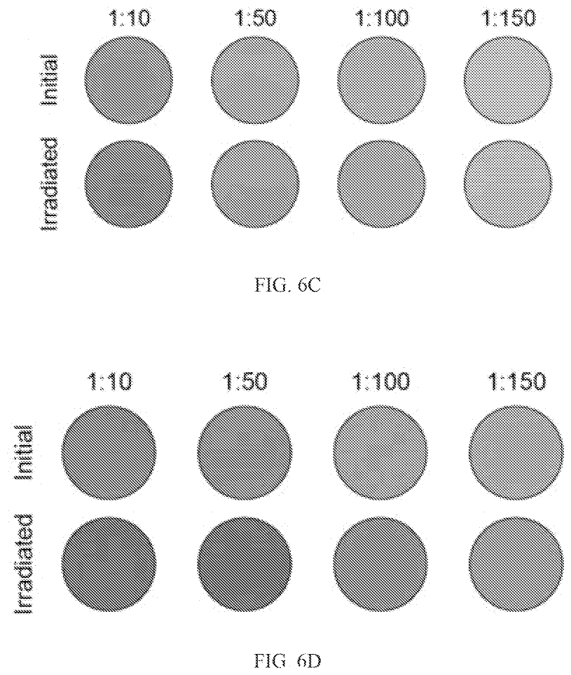

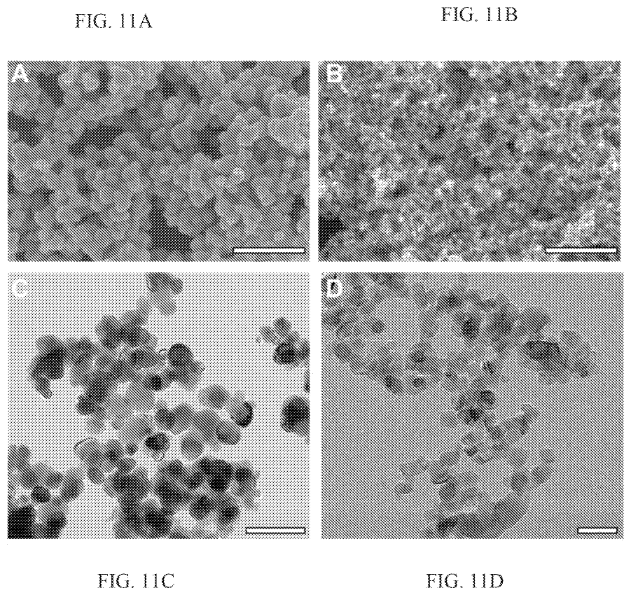

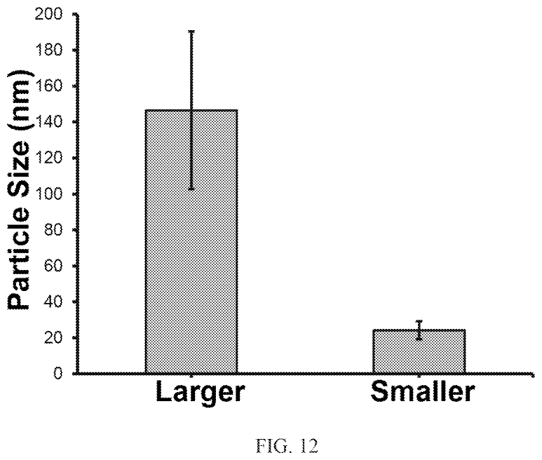

Incorporation of TiO₂, a common photocatalyst, into the formulations facilitated Xa reduction and color change in response to irradiation. Two different sizes of TiO₂ particles —146.5±43.9 nm and 24.2±5.0 nm—were used. It was hypothesized that decreasing the particle size would increase the surface area of the TiO₂, providing more accessible surface area for photoreduction and stronger subsequent color changes (FIG. 11A and 11B). Samples were prepared with 1:10, 1:50, 1:100, and 1:150 molar ratios of Xa to TiO₂ for both particle sizes and irradiated using simulated solar light, imaging the samples every 5 minutes for 60 minutes to record color change (FIG. 6A-6E). For the 1:10 sample with both larger (FIG. 6A) and smaller (FIG. 6B) TiO₂ particles, 4.3±1.2° and 1.8±0.6° changes in hue angle were observed, respectively. Compared to the other conditions, these changes were small and may indicate that there was not enough accessible TiO₂ to fully catalyze Xa reduction (FIG. 6C). In samples prepared with larger TiO₂ particles, differences in the hue angle of 11.0±1.5°, 11.8±1.8°, and 14.5±0.4° were observed for the 1:50, 1:100, and 1:150 samples, respectively. An obvious shift from yellow to red indicated that Xa was reduced (FIG. 6A and FIG. 6C). However, these results showed that there was not a steady change in hue angle over the full 60-minute period. The 1:50 and 1:100 samples reached 85% of the total hue angle change in 15.5±0.1 and 12.5±4.3 minutes, respectively, while the 1:150 sample achieved 85% of the total hue angle change in only 4.2±0.4 minutes. These results demonstrated a direct correlation between TiO₂ loading density and the rate of Xa photoreduction.

Color change after irradiation was even more prominent in the 1:50, 1:100, and 1:150 samples with smaller TiO₂ particles (FIG. 6B and FIG. 6D). In each case, there was a significant decrease in hue angle after only 5 minutes of irradiation. For the 1:150 sample, over 50% of the hue angle change occurred in the first 5 minutes of irradiation. The difference in the hue angle before and after irradiation was 21.5±1.5°, 34.0±3.3°, and 44.1 ±1.8° for the 1:50, 1:100, and 1:150 samples, respectively. These results supported the hypothesis that increasing the surface area of available TiO₂ in the coating would lead to enhanced photoreduction of Xa and strong color change. For example, a 22.8±0.9% change in hue angle was observed for the 1:150 sample with larger TiO₂ particles, and a 77.4±1.2% change in the 1:150 sample with smaller TiO₂ particles. Smaller TiO₂ particles provided a greater ultimate color change in hue angle. In samples prepared using these particles, the rate at which maximum color change was achieved within 60 minutes did not change with increasing particle loading density. The 1:50, 1:100, and 1:150 samples with smaller TiO₂ particles reached 85% of their final hue angle change in 30.1±1.1, 31.1±11.0, and 32.1±2.1 minutes, respectively. These three results are not statistically different from one another, indicating that for all three of these conditions TiO₂ particles are sufficiently accessible to Xa embedded within the paint matrix. Additionally, TiO₂ acts as a whitening agent in the coatings, which allowed for controlling the brightness of the coatings (Table 5), resulting in a range of visible appearances before and after irradiation (FIG. 6E). Furthermore, because samples prepared with smaller TiO₂ particles achieved both a greater change in hue angle and required higher dose of radiation to reach their final color state compared to samples prepared with larger TiO₂ particles, small particle formulations offer more resolved control over final coating color.

TABLE 5
The brightness value (L) of each coating formulation
before and after 60 minutes of irradiation.

| Condition | TiO₂ Particle Size | Brightness (L) |
|---|---|---|
| 1:10 Before Irradiation | Larger | 59.1 ± 0.1 |
| 1:10 After Irradiation | Larger | 55.6 ± 0.3 |
| 1:10 Before Irradiation | Smaller | 54.0 ± 1.2 |
| 1:10 After Irradiation | Smaller | 49.4 ± 0.8 |
| 1:50 Before Irradiation | Larger | 66.3 ± 0.6 |
| 1:50 After Irradiation | Larger | 63.6 ± 0.7 |
| 1:50 Before Irradiation | Smaller | 58.9 ± 1.8 |
| 1:50 After Irradiation | Smaller | 53.6 ± 2.3 |
| 1:100 Before Irradiation | Larger | 70.3 ± 1.2 |
| 1:100 After Irradiation | Larger | 67.3 ± 1.7 |
| 1:100 Before Irradiation | Smaller | 63.3 ± 0.6 |
| 1:100 After Irradiation | Smaller | 58.3 ± 0.2 |
| 1:150 Before Irradiation | Larger | 74.1 ± 1.2 |
| 1:150 After Irradiation | Larger | 71.8 ± 1.1 |
| 1:150 Before Irradiation | Smaller | 67.6 ± 1.9 |
| 1:150 After Irradiation | Smaller | 63.7 ± 2.0 |

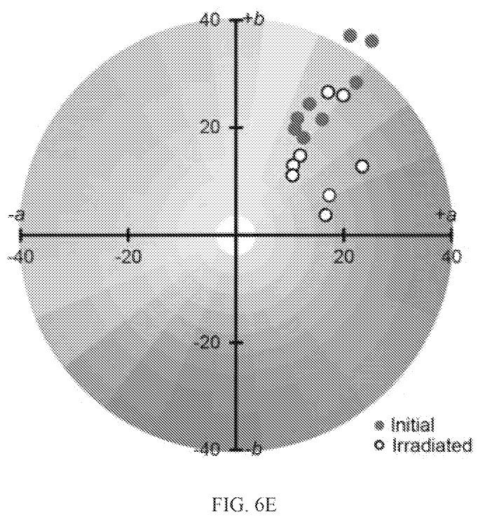

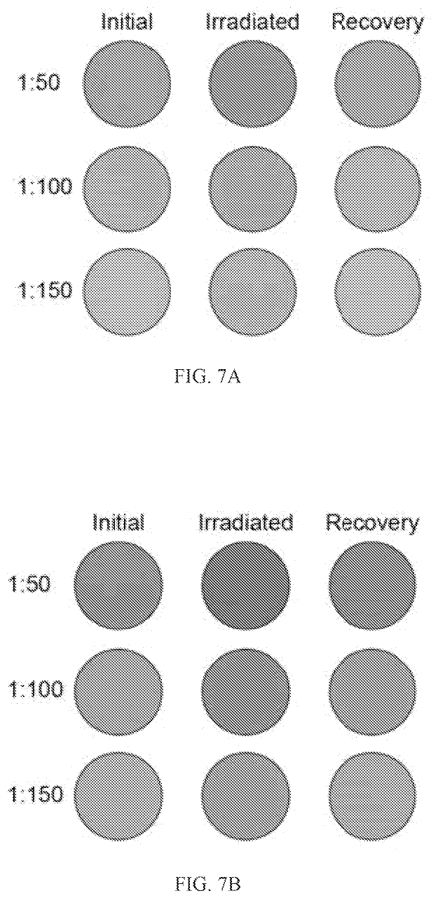

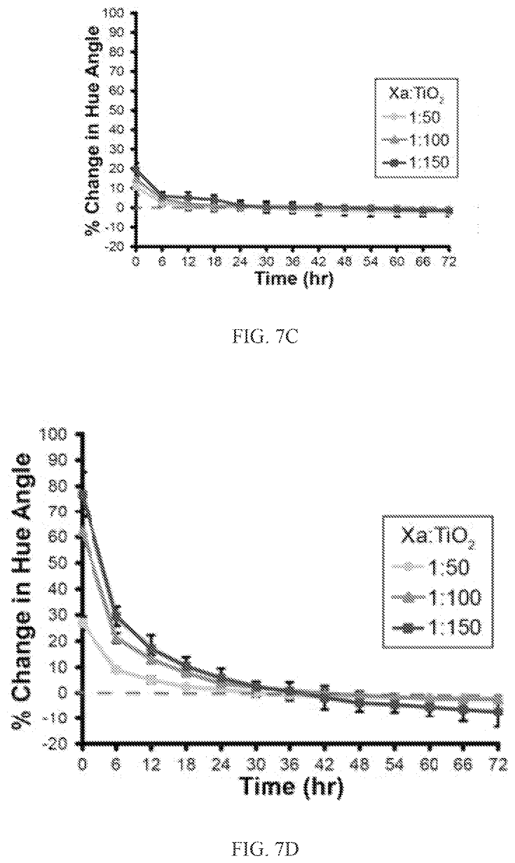

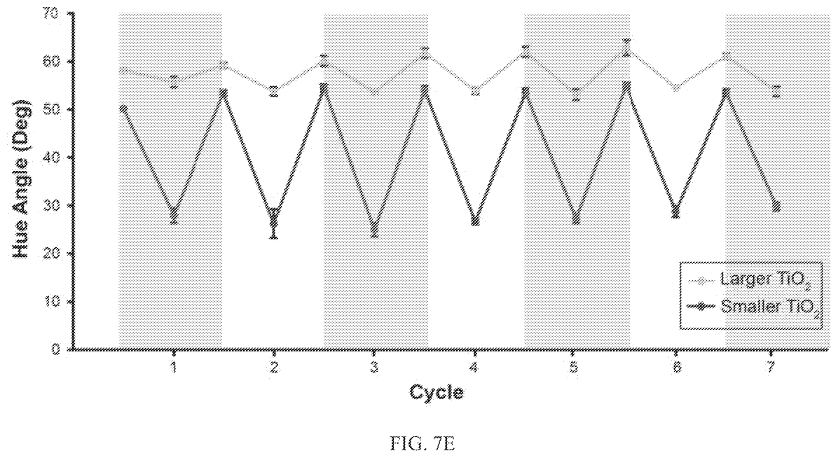

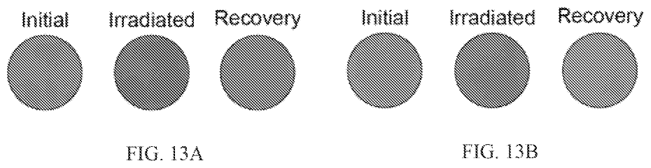

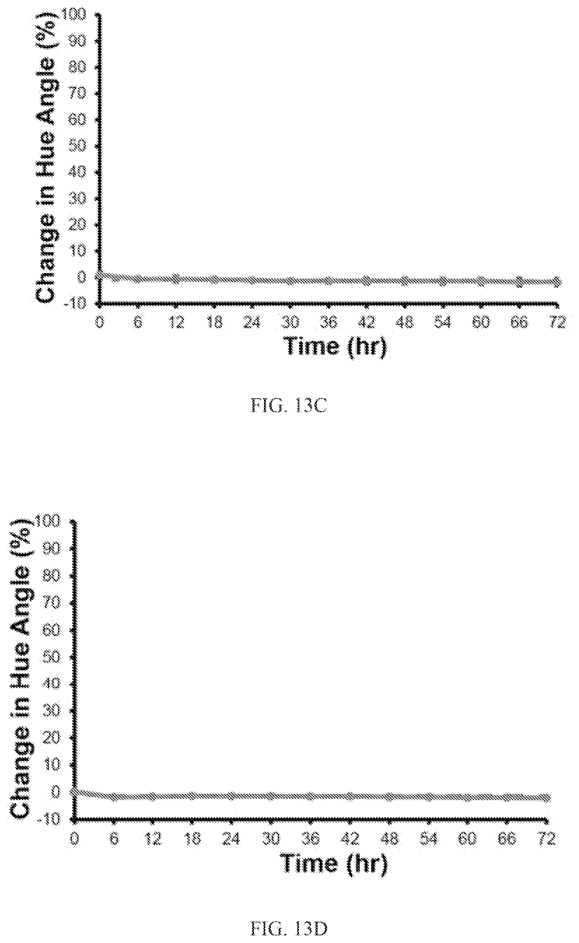

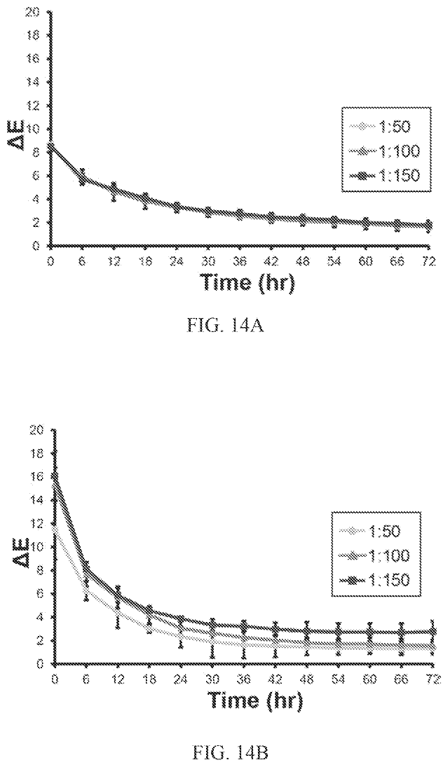

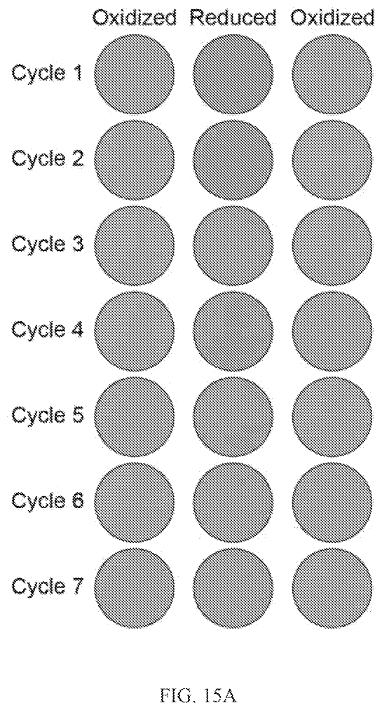

Relaxation Experiments: It was observed that after irradiating these samples, all of the coatings reverted back towards their original color in the absence of sunlight (FIG. 7A and 7B). To investigate (i) whether the coatings could fully recover their initial color and (ii) how many times the coatings could cycle between yellow and red while maintaining their color, the coatings were irradiated for 30 minutes at 1100 W m⁻², then color recovery was tracked over the course of 72 hours. The percent change between the initial hue angle and the hue angle at a given timepoint was calculated to quantify color change and extent of recovery. For the 1:10 samples both prepared with larger and smaller TiO₂ particles, a minimal initial change in hue angle was observed and these conditions were not included in the color recovery experiments (FIG. 13A-13D). Overall, it was observed that 50% of hue angle recovery occurred within the first 4 hours of relaxation (FIG. 7C and 7D) for all conditions. The coatings recovered to 99% of their initial hue angle after 16.7±15.0, 23.3±24.8,and 30.7±15.9 hours for the 1:50, 1:100, and 1:150 samples with larger TiO₂, and 26.7 ±4.9, 39.7±5.5, and 36.7±9.2 hours for the 1:50, 1:100 and 1:150 samples with smaller TiO₂ particles, respectively. On average, the samples prepared with larger TiO₂ particles recovered faster than their smaller particle counterparts, which may be due to their smaller initial color change upon irradiation. However, color change upon irradiation was less consistent in formulations prepared using larger TiO₂ samples compared to smaller particles. Interestingly, in most cases, hue angle was restored and then surpassed the original formulation in the opposite direction of the initial color change.

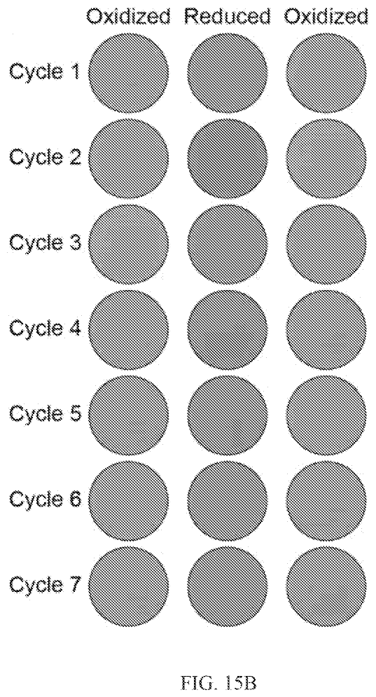

To further characterize color changes in the samples, the ΔE values were calculated (Equation 2) to quantify the difference between colors of the coatings before initial irradiation and after relaxation and color recovery. Generally, when ΔE<1, the difference in the color of two samples is undetectable to the human eye, and when 1<ΔE<2, the difference in color between two samples is only detected through close observation or by an experienced observer. At the end of the 72-hour relaxation period, the ΔE values for the 1:50, 1:100, and 1:150 samples were 1.7±0.1, 1.7±0.5, and 1.8±0.3 for the samples with larger TiO₂ particles, and 1.3±0.4, 1.6±0.5, and 2.7±1.0 for the samples prepared with smaller TiO₂ particles (FIG. 14A-14B). These results further demonstrate the reversibility of the photochromic capabilities of these coatings, and that this behavior enables effective recovery to colors that are nearly indistinguishable from unirradiated samples.

Next, it was explored how many times these coatings could transition between the oxidized and photoreduced forms without color degradation. To do this, samples were prepared with a 1:100 molar ratio of Xa to TiO₂ using both sizes of TiO₂ particles. These samples were irradiated using simulated solar light for 30 minutes and then stored in the dark for 48 hours (FIG. 7E). For both formulations, a smaller change was observed in hue angle before and after the first irradiation compared to hue angle differences in later cycles. The hue angle changed by 2.5±0.8° and 22.2±1.3° on average in the initial irradiation cycle, but 7.4±1.3° and 26.6±1.9° on average in subsequent irradiation cycles of the samples containing larger and smaller TiO₂ particles, respectively. It is also interesting to note that for both conditions, after the initial irradiation, the oxidized form of the two coatings had hue angles that were 5.2±2.3% and 7.6±1.3% greater than the hue angle of the initial coating on average. This could potentially be attributed to a small amount of photobleaching at the surface of these paint films during initial irradiation events.

Overall, it was determined that both conditions offer repeatable switching between the oxidized and reduced forms of Xa without meaningful color loss (FIG. 7E and FIG. 15A-15B). For the 1:100 condition containing larger TiO₂ particles, variation in the average hue angle over seven cycles was±1.7° for the oxidized form and ±0.9° for the reduced form. Variation in average hue angle for both the oxidized and reduced form was ±1.6° over seven cycles for coatings containing smaller TiO₂ particles. In electrochromic devices, Xa has offered reproducible color switching over more than 350 cycles, indicating that these coatings may be able to offer functional color switching over a long performance lifetime.

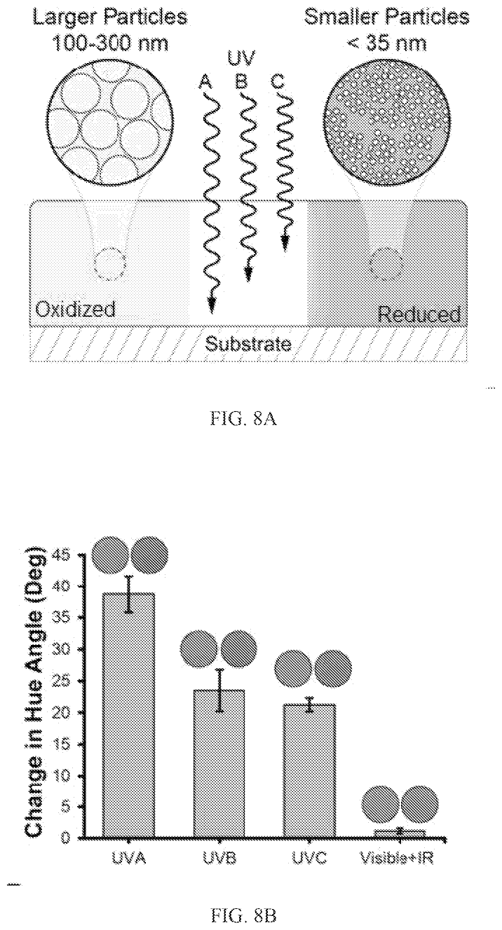

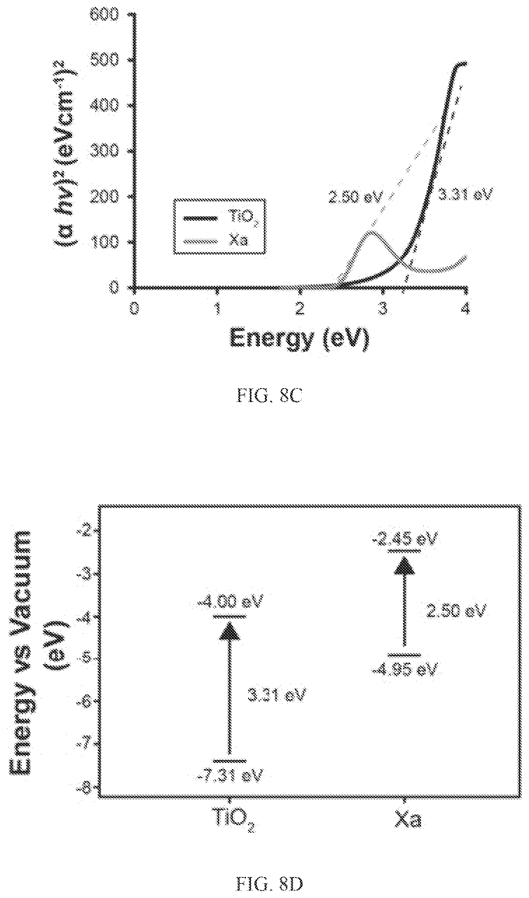

Investigating the Mechanism of the Coating Photoreduction: The next goal was to deduce whether dynamic color change by the coatings was dependent on wavelength of incident radiation. Samples were prepared with a 1:100 molar ratio of Xa to TiO₂ using the smaller particle size and they were exposed to a consistent radiation dose (30 J cm⁻²) at 254 nm (UVC), 302 nm (UVB), 365 nm (UVA), and 400-1100 nm (visible-nIR). The results revealed that UVA radiation caused the greatest shift in hue angle while visible-nIR radiation generated the smallest color change (FIG. 8B). The difference in the hue angle before and after irradiation was 38.7±2.9° and 1.2±0.4° for UVA and visible-nIR radiation, respectively. Samples irradiated with UVB and UVC radiation had a hue angle change of 23.5±3.3° and 21.3±1.1°, and were not statistically significantly different from each other.

Owing to the wide bandgap of TiO₂, minimal color change was observed in coating samples that were irradiated with visible-nIR light. Anatase and rutile, two of the most common crystal forms of TiO₂, require radiation with less than 400 nm wavelengths to move electrons to an excited state. Therefore, the energy produced by the visible-nIR radiation was not sufficient to excite electrons in TiO₂. As described previously, there is minimal change in the hue angle of coatings that do not contain TiO₂ before and after irradiation, so this result further highlights that TiO₂ plays an important role in the color changing mechanism of the paints described herein.

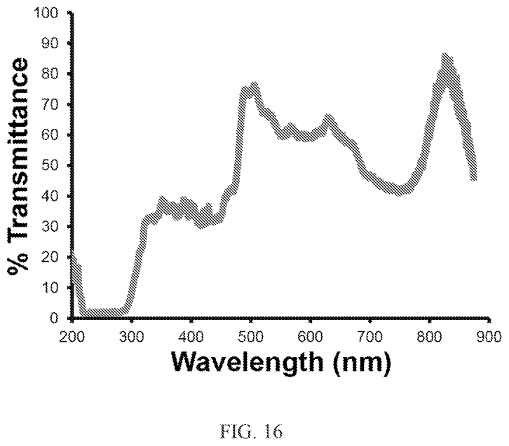

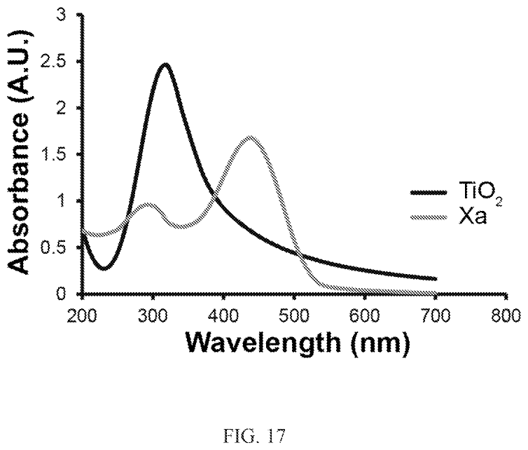

Because any radiation with a wavelength shorter than 400 nm is capable of exciting electrons in TiO₂, it was interesting that UVA radiation generated a greater color change in the samples compared to UVB and UVC radiation (FIG. 8B). To address this, the transmission spectrum was measured for coatings prepared using only polyurethane base material (FIG. 16). These results revealed that the polyurethane coating has low transmittance at representative wavelengths in the UVB and UVC regions, but readily transmits longer UVA wavelengths. It is possible that these energies were not able to penetrate the polyurethane matrix and only triggered Xa color change of the molecules at shorter penetration depths within the surfaces of the coatings. Because there is a significantly greater transmittance of UVA wavelengths through the coatings, these wavelengths likely penetrated deeper into the formulations to promote color change throughout the thickness of the sample as opposed to just on the surface, leading to more intense color changes (FIG. 8A and 8B).

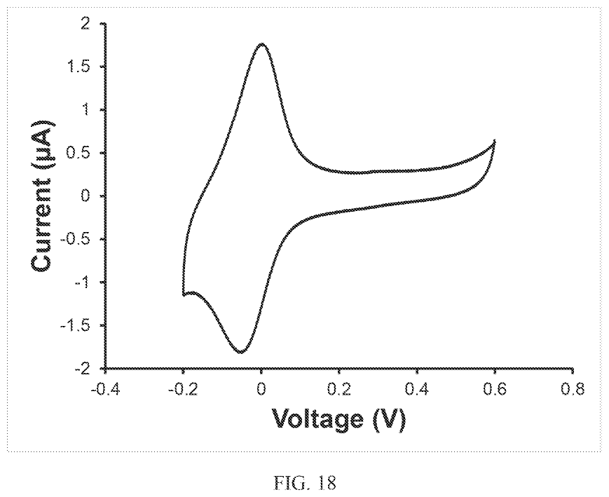

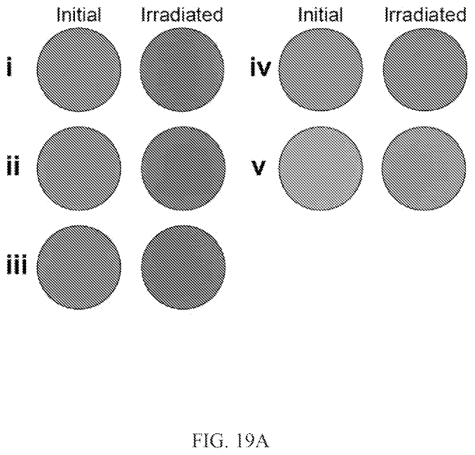

To further explore the mechanism underlying Xa-TiO₂ photochromism, estimated values for the energy band gaps of both TiO₂ and Xa were extrapolated. To do this, the absorbance spectra of both materials (FIG. 17) was measured and then the spectra were converted to Tauc plots using Equation 3. The calculated estimates for the direct energy bandgaps of TiO₂ and Xa were 3.31 eV and 2.50 eV, respectively (FIG. 8C and FIG. 18). Overall, the energy bandgap of TiO₂ is greater, which supports other experimental findings that its absorption is limited to the UV portion of the solar spectrum. However, Xa has a smaller bandgap, supporting its broader absorption spectrum which spans the UV and visible regions (FIG. 8D, FIG. 17). Based on these calculations, without wishing to be bound by theory, one hypothesis is that solar illumination may elicit differential electron injection between Xa and TiO₂, resulting in redox-based color change of the paint formulations.

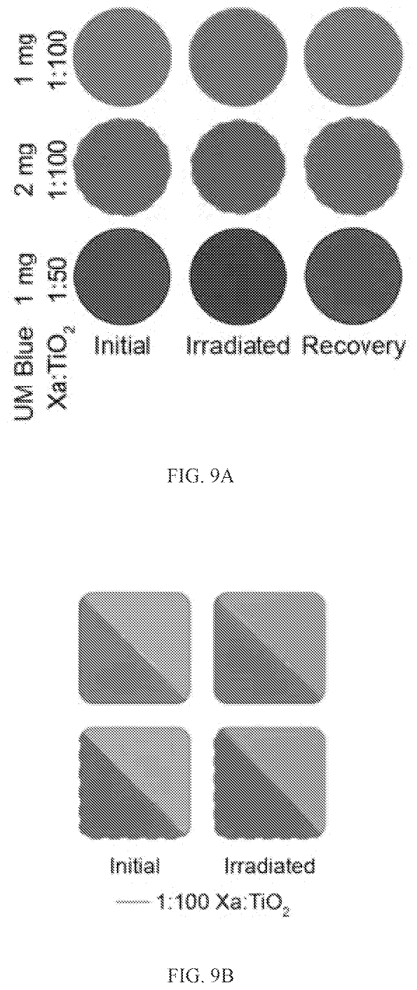

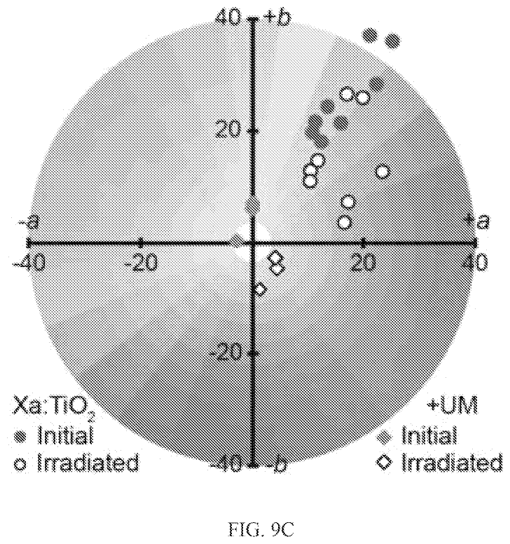

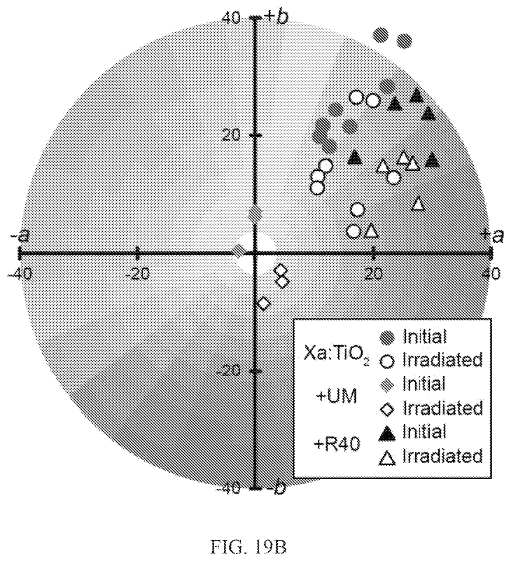

Alternative Colors and Patterning: Next, potential applications of the coatings were explored by increasing the range of potential colors and performing selective irradiation to create transient geometric patterns of photoreduced Xa in the coatings. Using varying concentrations and sizes of TiO₂ particles in the formulation design, a color palette spanning yellows, tans, and reds was established (FIG. 6C-6E). To further diversify the range of accessible colors, supplementary, non-photoresponsive natural pigments were added to blend against the dynamic color range of photoresponsive Xa-TiO₂ combinations (FIG. 9A-9C). Ultramarine, a commercially available form of the natural blue pigment lazurite, was added to the 1:50 and 1:100 Xa:TiO₂ (smaller particle) coating formulations in 1 mg increments to produce three different shades of green. When irradiated, all samples shifted toward a purple hue (FIG. 9A). Increasing the ratio of ultramarine (UM) to TiO₂ shifted blended colors toward blue tones, while the red color of photoreduced Xa blended with smaller quantities of UM to shift irradiated paints toward a deeper purple tone. All formulations shifted back toward their original color in the absence of sunlight. Additionally, individual samples composed of multiple color formulations that provided unique photochromic shifts were prepared, demonstrating more complex designs and increased hue diversity per area (FIG. 9B). These new colors offered additional chromaticity range over the original formulations (FIG. 9C). To further demonstrate this concept, different quantities of soluble red dye were incorporated into the original formulations, demonstrating that a variety of colorant types can be combined to diversify color using this approach (FIG. 19A-19B).

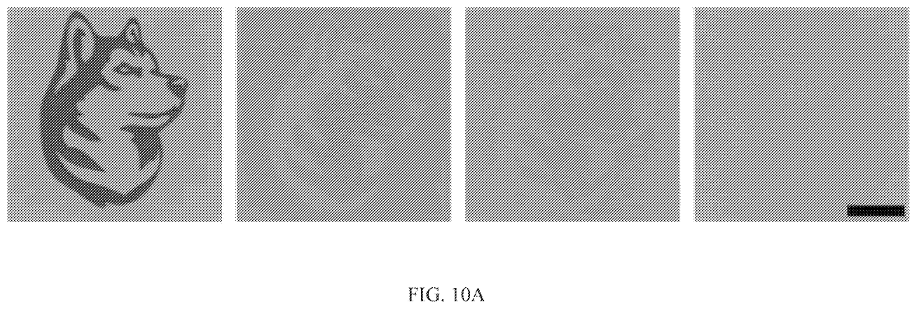

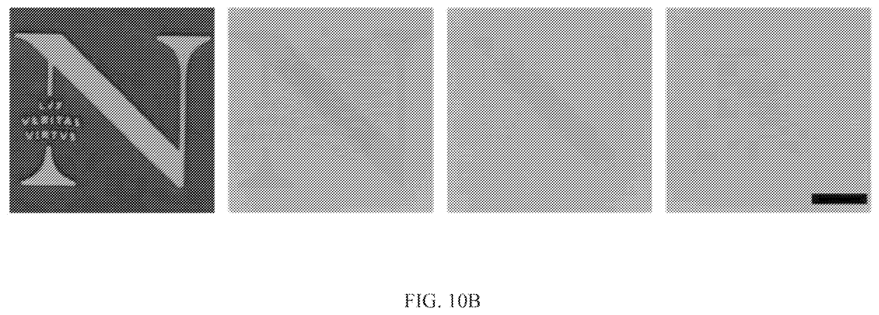

Finally, a proof-of-concept experiment was performed to demonstrate temporary complex geometric designs in these coatings using sunlight. To do this, patterned adhesive tape made using a CO₂ laser masked selected regions from solar radiation, irradiating only selected areas to create visual designs (FIG. 10A-10B). This approach provided resolved patterns after irradiation, enabling visual identification of the intended design. Over time, these designs disappeared as photoreduced regions of the coating relaxed toward their original color, and these coated substrates could be used to create different geometric patterns. These patterns faded over time to yield a blank, regenerated substrate. In the future, selective irradiation of patterned photoresponsive coatings spanning a broad color palette could be used to create complex designs and images that are responsive to light in the surrounding environment.

Spray-processable photochromic coatings have been developed composed of the natural biochrome Xa and the photocatalyst TiO₂ that can reversibly shift between yellow (oxidized) and red (reduced) colors in response to solar radiation. In these systems, the presence and form of TiO₂ was critical to the accessible color range and extent of color change, where the combination of these materials led to photoreduction in as little as 5 minutes of solar exposure. This process was reversible in the absence of sunlight, and color change could be induced at least 10 times with no measurable loss of color or signs of pigment degradation. Without wishing to be bound by theory, one potential explanation for this phenomenon is that UV radiation promotes electron injection between Xa and TiO₂, potentially in a closed loop to elicit reversible Xa photoreduction. While this hypothesis is yet to be explored, it does demonstrate an important first step in understanding of dynamic visible coatings using natural colorants that could potentially be used in consumer goods or in the design of future low-power optically-active materials.

### Experimental Section

Xanthommatin Synthesis: Xanthommatin was synthesized via the oxidative cyclization of 3-hydroxy kynurenine (3OHK) according to a previously published protocol. In summary, 3OHK (8 mg) was first dissolved in sodium hydroxide (1 mL, 25 mM), then potassium ferricyanide (33 mg dissolved in 1 mL of water) was added dropwise to the solution under stirring. The solution was covered to protect it from light, and it was allowed stir for 90 minutes at room temperature. Afterwards, hydrochloric acid (1 mL, 1 M) was added dropwise and the solution stirred for 5 minutes to precipitate the Xa. The precipitate was then washed via centrifugation three times with cold water and the resulting material stored in a 4° C. fridge.

Preparation and Application of Xa Coatings: The paint formulations consisted of a 1:10, 1:50, 1:100, or 1:150 molar ratio of Xa to TiO₂ dissolved or suspended in a water-based polyurethane matrix (Rust-Oleum 6711). Two different sizes of TiO₂ particles were tested in these experiments. To prepare the samples, the Xa (1 mg) and TiO₂ (0.0019 g, 0.0094 g, 0.0189 g, or 0.0283 g) were first mixed into separate portions of the polyurethane paint (0.5 g), and then the two solutions were combined (1 g total). The sample was then sonicated for 10 minutes and vortexed for one minute, then this process was repeated three times to produce a uniform sample.

To apply the paint in an even manner, a stencil made of masking tape was prepared with a 25.4×25.4 mm square cutout and attached to a piece of glossy cardstock (Leneta). The paint sample (0.8 g) was applied to the substrate with an airbrush (Model G233, Master Airbrush). It was critical to vigorously vortex the sample before applying the paint to ensure that all the TiO₂ was fully suspended. The samples dried for at least 12 hours before irradiation or analysis.

Irradiation of Xa Coatings: To examine the change in the paint color from irradiation over time, a flatbed photo scanner (Epson Perfection V39) was first used to obtain a high-resolution image (600 dpi) of the original sample. Two images were obtained every time a sample was imaged. One image was taken with an auto-exposure feature activated and the other was with no image modifications. The figures in the present description are the auto-exposed images, but all the data were collected off the original, unmodified images. After imaging, the sample was irradiated using an arc lamp solar simulator (MKS Instruments, Newport Corporation) at a solar power of 1100 W m⁻² for 60 minutes. The samples were removed every five minutes to collect a high-resolution image to track the color change of the sample. The results are reported as an average of three replicates and the error as ±one standard deviation.

Color Analysis: To quantify the color changes in the samples due to irradiation, values in the CIELAB color space were measured using ImageJ. In this color space, the L value represents the brightness of the sample and ranges from 0 (black) to 100 (white). The a value represents red (positive values) to green (negative values) chromaticity and the b value represents yellow (positive values) to blue (negative values) chromaticity. These values can be used to calculate the hue angle (Equation 1) and ΔE value (Equation 2) of each sample. In Equation 1, h° is the hue angle, and a and b are the CIELAB chromaticity values. In Equation 2, ΔE is the change in color between the initial and current sample, and ΔL, Δa, and Δb are the difference between the L, a, and b values of the original and current sample.

$$h ° = {tan}^{- 1} ( \frac{b}{a} ) \qquad ( 1 )$$

$$Δ E = \sqrt{Δ {L}^{2} + Δ {a}^{2} + Δ {b}^{2}} \qquad ( 2 )$$

Color Recovery of Xa Coatings: To determine how long it takes for the samples to revert to the original color after irradiation, the original sample was scanned then irradiated with the solar simulator for 30 minutes at 1100 W m⁻². An image of the irradiated sample was obtained every hour for 72 hours. The results are an average of three formulation replicate samples and the error is reported as standard deviation.

Color Change of Coatings with Ultraviolet Radiation: For this set of experiments, a formulation was chosen that consisted of a 1:100 molar ratio of Xa to TiO₂ with the smaller particle size. The samples were scanned with a flatbed photo scanner prior to irradiation. To irradiate the samples, a handheld UV lamp (Analytik Jena) was used that emitted light at 254 nm (UVC), 302 nm (UVB), or 365 nm (UVA). The dose of irradiation that the samples were exposed to was controlled by adjusting the distance of the sample from the lamp to calibrate the irradiance. A UVA/B radiometer (SPER Scientific, 290-370 nm spectral range) was used to adjust the irradiance to 3.5 and 6.0 mW/cm² in the UVA and UVB regions respectively. In addition, a UVC radiometer (General Tools, 220-275 nm spectral range) was used to set the irradiance to 3.5 mW cm⁻². All samples were exposed to 30 J cm⁻² of irradiation and imaged with the photo scanner after irradiation. The results are an average of three replicates and the error is reported as standard deviation.

Color Change of Coatings with Visible/IR Radiation: In addition to ultraviolet irradiation, the extent of color change in the coating was determined when they are exposed to solely to visible/IR radiation (400-1100 nm). A UV filter film that blocked approximately 90% of light under 390 nm was applied onto the arc lamp solar simulator to isolate the visible/IR regions. To achieve an energy dosage of 30 J cm⁻², the lamp was calibrated to irradiate the samples at 100 mW cm⁻², and the samples (1:100 molar ratio of Xa to TiO₂ with the smaller particles) were irradiated for 5 minutes. A high-resolution image of the sample was taken before and after irradiation. The results are the average of three independent samples and the error is reported as ±one standard deviation.

Statistical Analysis: All statistical analysis was done with a one-way ANOVA test in Microsoft Excel. The significance threshold (p-value) was set to 0.05. If any results were statistically significant from each other (F>F_{crit}) a Tukey test was performed to determine which values were different from each other, and the significance threshold was also set to 0.05.

Energy Bandgap Calculations: To determine the energy bandgaps of TiO₂ and Xa, Tauc plots were generated from the absorbance profiles with Equation 3. The first variable, α, is the absorption coefficient and is determined by Equation 4. Next, his Planck's constant (h=6.62×10⁻³⁴ J s), v is the frequency of incident light (v=c/λ, where c is the speed of light and λ is the wavelength), A is the optical constant, and E_{g} is the bandgap energy (E_{g}=1240/λ). Lastly, n determines the type of bandgap, where n=½ for a direct bandgap calculation, and n=2 for an indirect bandgap calculation.

$${( α hv )}^{\frac{1}{n}} = A ( hv - {E}_{g} ) \qquad ( 3 )$$

$$α = ( 2.3 \; 03 \times Absorbance \qquad ( 4 )$$

To produce the Tauc plots, the bandgap energy (E_{g}) was plotted as the x-axis and (αhv)^{1/n} as the y-axis for both direct and indirect bandgaps. For both the TiO₂ and Xa, the direct bandgap equation was a better fit for the data. A tangent line was drawn over the linear portion of the plot in Origin, and the x-intercept was calculated. This value is the energy bandgap of the materials.

Development of Alternative Coating Colors: Expanding the color palate of the paint formulations was achieved by incorporating additional colorants to alter both the initial and irradiated color of the sample. To shift the color of the formulations from tan to green, 1 and 2 mg of ultramarine blue was added to the 1:100 Xa to TiO₂ formulation and 1 mg of ultramarine blue was added to the 1:50 Xa to TiO₂ formulation. The smaller TiO₂ particles were in these formulations. The samples were applied in the same manner previously described and the samples were irradiated for 30 minutes at 1100 W m⁻². The samples were imaged before irradiation, after irradiation, and 24 hours after irradiation to demonstrate that the coating could return to its initial color.

Production of Temporary Patterns on Coating Surfaces: Templates were created to selectively control which parts of the coating surface were exposed to sunlight. Three layers of masking tape were pressed together to create a thick coating to prevent any radiation from going through the tape and discoloring the covered portions. The designs were created using Adobe Illustrator and cut into the adhesive with a CO₂ laser system. The masks were placed on a coating prepared with a 1:100 molar ratio of Xa to the smaller TiO₂ particles and irradiated for 30 minutes at 1100 W m⁻². The adhesive was then peeled off the coating to reveal the design. The sample was scanned every hour for 72 hours to demonstrate that the pattern was temporary and disappeared over time.

### Methods

Scanning Electron Microscopy (SEM) Imaging: The larger and smaller TiO₂ particles were suspended in distilled water, the sample (20 μL) pipetted onto a silicon wafer (Ted Pella Inc.), and the water allowed to completely evaporate. Imaging the samples was performed with a scanning electron microscope (Scios 2 DualBeam, ThermoFisher Scientific).

Transmission Electron Microscopy (TEM) Imaging: The larger and smaller TiO₂ particles were suspended in ethanol (70% v/v) and a drop of each solution added onto a carbon film Cu grid. The samples were imaged with a transmission electron microscope (Titan Thermis 300 S/TEM, ThermoFisher Scientific).

TiO₂ Particle Size Measurement: The SEM images were used to measure the particle sizes of both TiO₂ samples in ImageJ. Fifty particles were measured for each condition. The results are presented as the average and the error is the standard deviation.

Transmittance Spectrum Measurement of the Polyurethane Matrix: The polyurethane matrix base paint was applied on a piece of glossy cardstock over a 25.4×25.4 mm surface with an airbrush. After the sample dried, the coating was peeled off the cardstock with the tape to create a transparent thin film. The transmittance of the sample was then measured with an Ocean Optics Flame spectrophotometer.

Absorbance Spectrum Measurements: Xanthommatin and TiO₂ paste (Aqua Solution Inc.) were diluted in distilled water and added to a 3 mL cuvette. The absorbance profiles were collected with a UV-Vis spectrophotometer (SpectaMax M5 series, Molecular Devices) from 200-700 nm.

Cyclic-Voltammetry Measurements: To determine the energy region of the highest occupied molecular level (HOMO) and lowest unoccupied molecular level (LUMO), cyclic voltammetry (CV) was conducted with a three electrode system of glassy carbon (GC) working electrode, silver-silver chloride (Ag/AgCl) in saturated potassium chloride (KCl) as reference, and Platinum (Pt) wire for counter electrode. The electrolyte was prepared by adding synthesized Xa (0.25 mg mL⁻¹) into phosphate buffered saline (0.1 M) and adjusting the pH to 7. The redox potential between a potential range of −0.2 to 0.6 V was measured with scanning rate of 100 mV s⁻¹. To determine the HOMO and LUMO region, the following equations were used to extrapolate the oxidation and reduction peaks related to electron and hole injection into the conduction and valence bands In these equations, E_{g} was calculated based on the UV-Vis absorption spectra and Tauc plots (FIG. 17 and FIG. 8C respectively).

$${E}_{NHE} = {E}_{Ag / AgCl} + 0 \text{.197}$$

$${E}_{HOMO} = - e ( {E}_{oxidation vs NHE} + 4.75 ) ( eV )$$

$${E}_{LUMO} = - e ( {E}_{r e d u c tion vs NHE} + 4.75 ) ( eV )$$

$$or {E}_{LUMO} = {E}_{g} + {E}_{HOMO}$$

Development of Different Coating Colors with Red Dye 40: To further expand the color palette of the coatings, a common red colorant called Red Dye 40 was incorporated into the formulations. For the first set of experiments, the formulation was prepared with the 1:50 molar ratio of Xa to TiO₂ with the smaller TiO₂ particles (Method 4.2) and added Red Dye 40 in water (1, 2.5, and 5 μL, 0.5% w/w). In the next experiments both the 1:100 and 1:150 Xa to TiO₂ (smaller particles) formulations were prepared and Red Dye 40 (10 and 2.5 μL, respectively) added. The samples were applied in the manner previously described and irradiated for 30 minutes at 1100 W m−2. The samples before and after irradiation were imaged and their LAB values measured with ImageJ.

### REFERENCES

C. S. Henshilwood, F. d′Errico, K. L. van Niekerk, Y. Coquinot, Z. Jacobs, S. E. Lauritzen, M. Menu, R. Garcia-Moreno, Science 2011, 334 (6053), 219, DOI: 10.1126/science. 1211535.

M. Carciumaru, E. C. Nitu, O. Cirstina, Comptes. Rendus. Palevol. 2015, 14 (1), 31, DOI: 10.1016/j.crpv.2014.05.003.

V. Opris, A. Velea, M. Secu, A. M. Rostas, A. T. Buruiana, C. A. Simion, D. A. Mirea, E. Matei, C. Bartha, M. Dimache, C. Lazar, J. Archaeol. Sci. Rep. 2022, 42, DOI: 10.1016/j.jasrep.2022.103402.

A. S. Cavalheri, A. Balan, R. Kunzli, C. J. L. Constantino, Vib. Spectrosc. 2010, 54 (2), 164, DOI: 10.1016/j.vibspec.2010.09.004.

A. Radini, M. Tromp, A. Beach, E. Tong, C. Speller, M. McCormick, J. V. Dudgeon, M. J. Collins, F. Ruhli, R. Kroger, C. Warinner, Sci. Adv. 2019, 5 (1), DOI: 10.1126/sciadv.aau7126.

I. Rudner, S. Afr. Archaeol. Soc. Goodwin Ser. 1983, 4, 14.

H. G. Friedstein, Journal of Chemical Education 1981, 58 (4), 291, DOI: 10.1021/ed058p291.

K. A. Wood, Prog. Org. Coat. 2001, 43 (1-3), 207, DOI: 10.1016/s0300-9440(01)00185-0.

A. Krolikowska, L. Augustynski, in 6th Transport Research Arena (TRA) 2016, 4000-4009.

M. Diebold, S. D. Backer, P. M. Niedenzu, B. R. Hester, F. A. C. Vanhecke, in Springer International Publishing, Cham 2022.

a) J. Honzicek, Ind. Eng. Chem. Res. 2019, 58 (28), 12485, DOI: 10.1021/acs.iecr.9b02567; b) R. A. Dickie, D. R. Bauer, S. M. Ward, D. A. Wagner, Prog. Org. Coat. 1997, 31 (3), 209, DOI: 10.1016/s0300-9440(97)00039-8.

a) P. Andersson, R. Forchheimer, P. Tehrani, M. Berggren, Adv. Funct. Mater. 2007, 17 (16), 3074, DOI: 10.1002/adfm.200601241; b) K. Madasamy, D. Velayutham, V. Suryanarayanan, M. Kathiresan, K. C. Ho, J. Mater. Chem. C. 2019, 7 (16), 4622, DOI: 10.1039/c9tc00416e; c) T. V. Nguyen, H. Do, T. Q. Trung, Q. V. Le, T. P. Nguyen, S. H. Hong, H. W. Jang, S. H. Ahn, S. Y. Kim, J. Alloys and Compd. 2021, 882, DOI: 10.1016/j.jallcom.2021.160718.

M. Xiao, Y. W. Li, J. Z. Zhao, Z. Wang, M. Gao, N. C. Gianneschi, A. Dhinojwala, M. D. Shawkey, Chem. Mater. 2016, 28 (15), 5516, DOI: 10.1021/acs.chemmater.6b02127.

G. P. Wang, X. C. Chen, S. Liu, C. P. Wong, S. Chu, ACS Nano 2016 , 10 (2), 1788, DOI: 10.1021/acsnano.5b07472.

Y. F. Yue, T. Kurokawa, M. A. Haque, T. Nakajima, T. Nonoyama, X. F. Li, I. Kajiwara, J. P. Gong, Nat. Commun. 2014, 5, DOI: 10.1038/ncomms5659.

a) P. J. Coelho, M. C. R. Castro, M. M. M. Raposo, J. Photochem. Photobiol. A. Chem. 2013, 259, 59, DOI: 10.1016/j.jphotochem.2013.03.004; b) S. D. Shim, T. H. Joo, S. C. Bae, K. S. Kim, E. Y. Kim, J. Phys. Chem. A. 2003, 107 (40), 8106, DOI: 10.1021/jp027837w.

M. L. Moser, G. H. Li, M. G. Chen, E. Bekyarova, M. E. Itkis, R. C. Haddon, Nano Letters 2016, 16 (9), 5386, DOI: 10.1021/acs.nanolett.6b01564.

a) Y. B. A. Liu, X. S. Cai, X. D. Xiao, J. X. Wang, G. Z. Sheng, G. Xu, Mater. Today Commun.2022, 30, DOI: 10.1016/j.mtcomm.2021.103090; b) P. A. Sullivan, D. J. Wilson, M. Vallon, D. Q. Bower, L. F. Deravi, Adv. Mater. Interfaces, DOI: 10.1002/admi.202202463.

G. T. England, C. Russell, E. Shirman, T. Kay, N. Vogel, J. Aizenberg, Adv. Mater. 2017, 29 (29), DOI: 10.1002/adma.201606876.

W. Zhang, X. Q. Ji, C. J. Zeng, K. L. Chen, Y. J. Yin, C. X. Wang, J. Mater. Chem. C 2017, 5 (32), 8169, DOI: 10.1039/c7tc02077e.

M. S. Jakovljevic, R. Kulcar, M. Friskovec, B. Lozo, M. K. Gunde, Dyes and Pigments 2020, 180, DOI: 10.1016/j.dyepig.2020.108482.

Q. S. Ye, R. Wang, S. T. Yan, B. L. Chen, X. Y. Zhu, J. Mater. Chem. B. 2022, 10 (14), 2617, DOI: 10.1039/d1tb02329b.

J. Deng, J. F. Li, P. N. Chen, X. Fang, X. M. Sun, Y. S. Jiang, W. Weng, B. J. Wang, H. S. Peng, J. Amer. Chem. Soc. 2016, 138 (1), 225, DOI: 10.1021/jacs.5b10131.

M. Li, Y. Wang, A. P. Chen, A. Naidu, B. S. Napier, W. Y. Li, C. L. Rodriguez, S. A. Crooker, F. G. Omenetto, PNAS U.S.A. 2018, 115 (32), 8119, DOI: 10.1073/pnas. 1805832115.

Y. X. Dong, A. Bazrafshan, A. Pokutta, F. Sulejmani, W. Sun, J. D. Combs, K. C. Clarke, K. Salaita, ACS Nano 2019, 13 (9), 9918, DOI: 10.1021/acsnano.9b04231.

J. H. Braun, A. Baidins, R. E. Marganski, Prog. Org. Coat. 1992, 20 (2), 105, DOI: 10.1016/0033-0655(92)80001-d.

P. S. Khiabani, A. H. Soeriyadi, P. J. Reece, J. J. Gooding, ACS Sens. 2016, 1 (6), 775, DOI: 10.1021/acssensors.6b00244.

a) K. Wiley, H. S. Forrest, Biochemical Genetics 1981, 19 (11-1), 1211, DOI: 10.1007/bf00484574; b) R. Futahashi, R. Kurita, H. Mano, T. Fukatsu, PNAS U.S.A. 2012, 109 (31), 12626, DOI: 10.1073/pnas. 1207114109.

D. J. Wilson, F. J. Martin-Martinez, L. F. Deravi, ACS Sens. 2022, 7 (2), 523, DOI: 10.1021/acssensors.1c02342.

S. Y. Lee, S. J. Park, J. Ind. Eng. Chem. 2013, 19 (6), 1761, DOI: 10.1016/j.jiec.2013.07.012.

M. L. Ronnier Luo, C., in (Ed.: C. Fernandez-Maloigne), Springer New York, NY 2013, Ch. 2.

ISO 11664-4:2008(E)/CIE S 014-4/E: Joint ISO/CIE Standard: Colorimetry-Part4: CIE 1976 L*a*b* Colour Space. 2007.

R. S. Berns, Billmeyer and Saltzman's Principles of Color Technology, John Wiley & Sons, 2019.

W. Mokrzycki, M. Tatol, Mach. Graph. Vis 2011, 20 (4), 383.

A. Kumar, T. L. Williams, C. A. Martin, A. M. Figueroa-Navedo, L. F. Deravi, ACS Appl. Mater. Interfaces 2018, 10 (49), 43177, DOI: 10.1021/acsami.8b14123.

S.-Y. P. Lee, S.-J., J Ind Eng Chem 2013, 19, 1761.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments contemplated herein.

1. A composition comprising xanthommatin, or a derivative or precursor thereof, and a paint matrix, wherein the xanthommatin, or a derivative or precursor thereof, is in non-aggregated form and is about 0.001% to about 20% weight/weight (w/w) of the composition.

2. (canceled)

3. (canceled)

4. The composition of claim 1, wherein the xanthommatin, or a derivative or precursor thereof, is in solution in the composition.

5. (canceled)

6. The composition of claim 1, wherein the paint matrix is a paint primer matrix.

7. (canceled)

8. (canceled)

9. (canceled)

10. (canceled)

11. The composition of claim 1, wherein the paint matrix comprises a reactive monomer or reactive pre-polymer and an aqueous solvent, or the paint matrix comprises an oil and a non-aqueous solvent.

12. The composition of claim 11, wherein the reactive monomer or reactive pre-polymer is urethane-based, amide-based, ester-based, saccharide-based, ethylene glycol-based, acrylate-based, or methacrylate-based.

13. (canceled)

14. (canceled)

15. The composition of claim 11, wherein the aqueous solvent comprises a mixture of water or a buffer and an organic solvent.

16. The composition of claim 15, wherein the aqueous solvent comprises acidic methanol.

17. (canceled)

18. (canceled)

19. (canceled)

20. (canceled)

21. The composition of claim 11, wherein the non-aqueous solvent is an organic solvent.

22. (canceled)

23. The composition of claim 1, wherein the paint matrix is about 65% to less than 100% w/w of the composition.

24. The composition of claim 1, further comprising one or more additional colorants.

25. (canceled)

26. The composition of claim 24, wherein the one or more additional colorants comprise a soluble dye.

27. (canceled)

28. The composition of claim 24, wherein the one or more additional colorants comprise a pigment.

29. (canceled)

30. The composition of claim 28, wherein the pigment is titanium dioxide.

31. The composition of claim 30, wherein the titanium dioxide has an average particle size of less than about 200 nm.

32. The composition of claim 24, wherein the one or more additional colorants, taken each alone or together, are about 0.001% to about 10% w/w of the composition.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. A method for modulating the thermal properties of a surface, the method comprising applying the composition of claim 1 to the surface, or a portion thereof, thereby forming a coating of the composition on the surface, or a portion thereof.

64. The method of claim 63, wherein the method modulates the actual or perceived temperature of the surface or a volume formed at least in part by the surface.

65. The method of claim 63, wherein the method modulates the actual or perceived temperature of a structure, a flat surface, or a vehicle.

66. (canceled)

67. The method of claim 65, wherein applying comprises spraying, brushing, or rolling the composition onto the surface, or a portion thereof.

68. (canceled)

69. (canceled)

70. (canceled)

71. (canceled)

72. (canceled)

73. (canceled)

74. A method for making a composition of claim 1, comprising dissolving xanthommatin, or a derivative or precursor thereof, in a paint matrix in an amount sufficient to achieve about 0.001% to about 20% weight/weight (w/w) of the xanthommatin, or a derivative or precursor thereof, in the composition.

75. (canceled)

76. (canceled)

77. The method of claim 74, comprising: (a) combining an aqueous solution or suspension of xanthommatin, or a derivative or precursor thereof, with a water-based paint matrix miscible with the aqueous solution or suspension, or (b) adding solid xanthommatin, or a derivative or precursor thereof, to a water-based paint matrix, thereby dissolving the xanthommatin, or a derivative or precursor thereof, in the paint matrix, optionally further comprising mixing the xanthommatin and paint mixture to uniformly distribute the xanthommatin, or a derivative or precursor thereof, throughout the paint matrix.

78. (canceled)

79. (canceled)
